(19) United States
(12) Patent Application Publication
(10) Pub. No.: US 2025/0369463 A1
(43) Pub. Date: Dec. 4, 2025

(54) CLAMP WITH A LIMITED INFINITELY VARIABLE DIAMETER WITHIN A FINITE CIRCUMFERENTIAL RANGE

(71) Applicant: Band-It-IDEX, Inc., Denver, CO (US)

(72) Inventors: Kevin Wagner, Denver, CO (US); Stephen C. Galante, Denver, CO (US); Marc Reich, Boulder, CO (US); Douglas Watchorn, Frenchtown, NJ (US)

(21) Appl. No.: 19/227,889

(22) Filed: Jun. 4, 2025

Related U.S. Application Data
(60) Provisional application No. 63/655,994, filed on Jun. 4, 2024.
(60) Provisional application No. 63/679,294, filed on Aug. 5, 2024.

(51) Int. Cl. F16B 2/08

(52) U.S. Cl. CPC F16B 2/08

(57) ABSTRACT

A clamp having a variable diameter is provided. The clamp includes a band extending from a first band end to a second band end and having a first receiver at the first band end. The clamp also includes a tension and buckle section fixed to the band. The tension and buckle section includes a second receiver and a slot. The first receiver is positioned in the slot and is movable within the slot such that movement of the first receiver increases or decreases a diameter of the clamp. The band forms a flush seal with a workpiece.

This U.S. Non-Provisional Patent application claims benefit of U.S. Provisional Application No. 63/655,994, filed Jun. 4, 2024, and U.S. Provisional Application No. 63/679,294, filed Aug. 5, 2024, the entire disclosure of which are hereby incorporated by references herein.

### FIELD OF THE INVENTION

Embodiments of the present invention are related generally to band clamps forming a 360 degree clamp around or seal with a work piece and in particular to a band clamp with an infinitely variable diameter within a finite circumferential range.

### BACKGROUND

Conventional band clamps are provided to an installer or user in one of two conditions, either with as a flat band or in a pre-formed closed loop. In automotive applications such as, for example, installing a flexible or rubber boot over an articulating joint, a band clamp is used to secure the boot to the articulating joint and to form a seal with the boot. The clamped boot prevents dirt or debris from contacting and collecting in the articulating joint. If the clamp is provided to an installer or user in a pre-formed loop, it is placed over the boot and installed. If the clamp is provided unformed and flat, an additional step is required of the installer to wrap the clamp around the boot and insert a free end of the band through a buckle to form a closed loop before completing the installation of the clamp. Automotive applications are just one example of the end use of band clamps. As understood by those of skill in the art, band clamps have a wide range of end use applications and all such applications are within the scope of the present disclosure.

While clamps pre-formed in a closed loop eliminate an installation step, other inefficiencies exist. Conventional clamps provided pre-formed in a closed loop are typically provided with a limited or specific diameter. Thus, continuing the same example, in applications involving multiple installation areas where the diameter of a rubber boot may be different at each installation area (whether on the same vehicle or across different vehicles), a different clamp for each different diameter must be used. As such, a user may need to have several different clamps in stock to accommodate each different diameter.

Further, with conventional clamps, the locking mechanism or buckle extends inwardly beyond the inner surface of the band. Therefore, when the band is positioned on a workpiece and subjected to tensioning, a full or complete seal between the inner surface of the band and the outer surface of the workpiece is not achieved. Rather, due to the buckle not being flush with the inner surface of the band, a full 360 degree seal cannot be achieved allowing debris and fluids to pass.

In addition, conventional clamps that use, for example, ear locks to lock the clamp in place may lose much of the clamp's retained force following completion of the clamping process. More specifically, in many instances, band clamps utilizing ear locks lose about two-thirds of their tension force relative to a maximum force when relaxed and require thicker materials to counteract for the loss and achieve targeted objectives. Further, ear locks are susceptible to damage and/or loss of a clamp load, are high profile, and cannot be taken apart and must be installed axially onto an assembly. Additionally, following installation, it is difficult to determine if the pinch feature of an ear lock was sufficiently tensioned.

### SUMMARY

To address these and other issues of long felt need in the automotive industry and other industries, a band clamp preformed in a closed loop having an infinitely variable diameter within a specific finite circumferential range, a method of manufacturing the clamp, and a method of installing the clamp are provided. The closed loop clamp, according to at least one embodiment of the present disclosure, beneficially has a diameter or circumference that is variably adjustable over a finite circumferential range such that the clamp can be used with workpieces of different diameters or circumferences. The term circumference as used herein is not limited to a circular shape but is intended to be broader and encompass varying perimeter shapes associated with differently shaped workpieces. The clamp includes a band extending from a first band end to a second band end and has a first receiver formed at the first band end. The clamp also includes a tension and buckle section positioned proximate the second band end. The tension and buckle section may be formed as one piece with the band or may be formed as a separate piece then joined together with the band. The term buckle as used herein is not intended to be limited to a mechanical structure where one structure restricts or limits movement of a second structure nor is it intended to solely encompass a component or structure that is separate from a band. Here, buckle is intended to include securement methods and techniques, including welding, that secure or lock movement of a band. The present disclosure also uses the terms outer and inner to refer to surfaces of a band. Because the function of a band clamp is to secure one or more objects, such as securing a boot to an articulating joint (as one example), in practice the band is wrapped around a workpiece. In this context the surface of the band touching the workpiece is the inner surface and the opposite surface of the band is the outer surface. However, it should be appreciated that the terms outer surface and inner surface are also applicable in the context of a band clamp prior to installation as those of skill in the art will appreciate which surface is which based upon the intended, prospective use of the band clamp.

The band is configured to form a coil or closed loop with the first band end engaged by a tension and buckle section positioned on the outer surface of the band. Because the locking mechanism or buckle is located on the outer side of the band and does not extend inwardly beyond the inner surface of the band, the band forms a 360 degree or full surface seal between the inner surface of the band and the outer surface of a workpiece. In conventional clamps, a conventional buckle extends below the inner surface of the band and rests on a surface of the workpiece. A step or gap is formed creating a leak path between the band, the buckle, and the workpiece (discussed in connection with the embodiment illustrated in FIG. 11). The presence of such a step and leak path may prevent a seal being formed between the clamp and the workpiece. Conventional clamps may include one or more dimples to reduce the leak path, however, such dimples do not enable a continuous seal around the workpiece. Thus, the clamp according to embodiments of the present disclosure, with a buckle located on the upper surface or on top of the band, beneficially enables a seal to be formed between the clamp and the workpiece.

The tension and buckle section also includes a slot. The slot is co-axial with a longitudinal axis of the band that extends for a distance between the first band end and the second band end of the band. A first receiver is associated with the first band end. When the band is formed into a closed loop, the first band end with the first receiver is positioned in the slot and moves within the extent of the slot. As the first receiver moves between the first end and second end of the slot, the circumference and diameter of the closed loop formed by the band increases or decreases, thereby enabling the clamp to have an infinitely variable diameter limited by the length of the slot. A tool can be used to tension the band over a workpiece (for example a boot) and, lock the band in place, as will be described in detail below. Thus, a band may be provided in a closed loop form with a first circumference or diameter sufficiently large enough to fit over a variety of differently configured or sized workpieces, e.g., of different perimeter or outer surface shapes, circumferences or diameters, and is capable of tensioning and locking along a continuum of circumferences or diameters within a finite range or continuum limited by the length of the slot and e achieve a complete or full 360 degree seal between the band and work piece.

The tension and buckle section by further include staging features that secure or hold the band in a closed loop configuration prior to using a tool to tension and lock the band about a workpiece. Staging or pre-forming the band into a closed loop can improve the efficiency of an installer by allowing the installer to place the staged, closed loop band at the desired location of a workpiece, and then utilize a tool to complete tensioning and locking of the band. The staging features include a ramp or tab extending outwardly from the upper surface of the band proximate the slot when the band is configured in a closed loop. The ramp or tab engages the lower surface of the first end of the band to frictionally hold the band in a closed loop configuration. Alternatively, one or more outwardly extending protuberances or dimples may be formed on the outer surface of the first end of the band that engage an aperture associated with the tension and buckle section when the band is pre-formed into a closed loop configuration. The protuberance or dimple engages the aperture to hold the band in a closed loop configuration. A plurality of protuberances or dimples may be formed along the upper surface of the first end of the band to provide multiple incremental closed loop configurations with different circumferences or diameters. Conversely, the tension and buckle section may be provided with an inwardly extending protuberance or dimple and the upper surface of the first band end provided with an aperture to receive the protuberance or dimple. As a further alternative, the slot of the tension and buckle section may be provided with one or more hooks that extend into the slot and narrow or reduce the width of the slot at one or more locations along the longitudinal length of the slot. The one or more hooks are configured to engage the first receiver as it moves along the length of the slot gradually decreasing the circumference or diameter of the closed loop. The one or more hooks allow the first receiver to move past, thereby narrowing the circumference or diameter of the closed loop, but inhibit the first receiver from reversing direction.

The staging features of the embodiments according to the present disclosure are further configured to allow a flat band to be initially staged into a closed loop shape, with one end of the band held by the second end of the band, subsequently un-staged or separated without damage to the band, and then re-staged. Thus, in one example, an installer may receive a band clamp according to embodiments of the present disclosure in a closed loop or staged configuration. However, the closed loop configuration may not allow the installer to properly position the band clamp on a workpiece. Therefore, the staging features permit the installer to separate or disconnect the two end of the band clamp in order to position the band clamp appropriately relative to the workpiece. The installer may then re-stage or reconnect the first and second ends into a closed loop at the correct location relative to the work piece. A tool my then be used to tension the band claim and complete the installation.

In other embodiments according to the present disclosure, one or both of the first band end and second band end may be provided with a tail extending outwardly in a direction coaxial with the longitudinal axis of the band. For example, a first tail, disposed at the first band end may have a lateral width that is narrower than the width of the band to facilitate positioning of the first end of the band within the tension and buckle section. In this scenario, the first receiver and the various staging features would be located on the upper surface of the first tail. In addition, a second tail may extend outwardly from the second band end in a direction coaxial with the longitudinal axis of the band. If the band includes the second tail, the inner surface of the first band end should include a recessed depression, groove or channel that receives the second tail when the band is configured into a closed loop. As the circumference or diameter of the closed loop is decreased, the depression, groove or channel assists in guiding the movement of the second tail and thereby maintains alignment of the first band end relative to the second band end. Because the depression, groove or channel is recessed, the second tail is positioned within the depression, groove or channel and allows the inner surface of the band to engage the outer surface of the workpiece. In other words, the second tail does not create a step or incongruity in the lower surface of the band what would cause a leak path between the band and the workpiece.

In at least one embodiment according to the present disclosure, a band clamp includes a band extending from a first band end to a second band end, the band having an outer surface and an inner surface, the band having a first receiver positioned at the outer surface proximate the first end, a tension and buckle section fixed to the outer surface of the band and having a first end and a second end spaced from the first end, and a slot in the tension and buckle section that extends from proximate the second end to proximate the second receiver, wherein, when the first receiver is positioned within the slot, the band forms a closed loop defining a circumference with the first receiver movable within the slot relative to vary the circumference of the closed loop.

The embodiments of the band according to the present disclosure may be locked or secured in a final configuration by different methods, For example, a punch may be used to deform the band relative to the tension and buckle section. Alternatively, welding may be utilized to lock the band in its final configuration. If welding is utilized, the band may further include a weld pad to protect the surface of the banding projection. In one example, the weld pad is located proximate the second end of the band at a location aligned with the tension and buckle section. The band may be stamped along a discrete portion of its length to form an outwardly protruding or raised section of the band. The raised section would have an outer surface extending outwardly above the outer surface of the band and an inner surface raised above the inner surface of the band. The weld pad creates a shield and buffer between the surface of the workpiece and the band to help redistribute the heat created during the welding process and protect the surface of the banding object from heat damage.

Different methods of manufacturing may be utilized to make the clamps described herein. According to embodiments of the present disclosure, the band and the tension and buckle section may be made individually and separately. For example, the band may be stamped or cut from a sheet or length of metal and the tension and buckle section may also be stamped or cut from a sheet or length of metal. Stamping allows for specific features to be formed into the band and into the tension and buckle section. If made separately, the tension and buckle section is then attached to the second end of a band, typically by welding, although adhesives and other methods of attachment known to those of skill in the art may be used. If a stamping process is used, multiple pieces may be stamped simultaneously. A laser or other cutting tool may be used to make specific shapes.

Alternatively, the tension and buckle section may formed integrally with the buckle from a single sheet of metal, for example, by stamping. A U-shaped cut may be made proximate the second band end and, in a subsequent step, the second band end is folded over the outer surface of the band. The second band end is then secured or affixed to the upper surface of the band to form a longitudinal slot with a first end and a second end. The side edges of the slot are defined by an arm extending along each lateral edge of the outer surface of the band. Portions of these two arms may also be affixed to the outer surface of the band. The slot is open at the newly created second band end. In a subsequent step, the first band end is positioned inside the slot to form a closed loop with the band. Here, the combination of the band and tension and buckle section may alternatively be formed from a continuous length of metal, for example, a coiled length of metal that has the same lateral width as a finished band. One or more bands may be stamped simultaneously with each band remaining connected to the next band in an end-to-end configuration. The length of metal may be re-coiled to create a continuous reel of bands in a compact format. The end band is pulled from the coil and detached as needed.

In at least one method for manufacturing a band according to the present disclosure, the method includes forming a band from a piece of material, the formed band having a first band end and a second band end spaced from the first band end, the band having an outer surface and an inner surface, the band having a first side and a second side spaced from the first side; making two parallel slots through the band proximate the second band end to create a first arm comprising a portion of the first side of the band and a second arm comprising a portion of the second side of the band, the first arm spaced from the second arm, the two slots having a first end and a second end, the second end of the two slots being closer to the second band end than is the first end of the two slots; folding each of the first and second arms proximate the second end of the two slots to form a tension and buckle section having an open slot that is spaced from and extends along a portion of the outer surface of the band; and connecting the first and second arms to the outer surface of the band.

A tool is used to tension and lock the finished band about a workpiece. The tool includes a first and second hook or finger that engage a first and a second receiver associated with the band, respectively. The first receiver is located proximate the first band end and, when the band is pre-formed into a closed loop, the first receiver is accessible through the open slot formed by the tension and buckle section. A second receiver is located proximate or near the first end of the slot. The first finger is movable toward and away from the second finger or, alternatively, both the first and second finger are movable toward and way from each other. The first finger engages the first receiver and the second finger engages the second receiver. Moving one receiver closer to the other receive reduces the circumference or diameter of the band in a closed loop configuration. Conversely, separating the two receivers increases the circumference or diameter of the band in a closed loop configuration. As the tool increases the tension in the band, the inner surface of the band maintains contact with the outer surface of the workpiece. In the example of the rubber boot discussed previously, the band presses the boot against the surface of a workpiece to form a seal resistant to leaking.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions. It should be understood, of course, that the invention is not necessarily limited to the particular embodiments illustrated herein.

FIG. 1 is an isometric view of a band clamp with a variable diameter according to at least one embodiment of the present disclosure;

FIG. 2 is an exploded side view of the band clamp of FIG. 1;

FIG. 3 is an isometric view of the band clamp of FIG. 2;

FIG. 4 is a second isometric view of the band clamp of FIG. 2;

FIG. 5 is a front, isometric view of the band clamp of FIG. 1;

FIG. 6 is a front, isometric view of the band clamp of FIG. 1;

FIG. 7 is a top view of a flat band according to at least one embodiment of the present disclosure;

FIG. 8 is a bottom view of the band of FIG. 7;

FIG. 9 is a top view of the band clamp of FIG. 1, in a flat state;

FIG. 10 is a bottom view of the band clamp of FIG. 9;

FIG. 11 is a side view of a conventional prior art clamp and a workpiece;

FIG. 12 is a side view of the band clamp of FIG. 1 and the same workpiece illustrated in FIG. 11;

FIG. 13 is a side view of the band clamp of FIG. 1;

FIG. 14 is a top, detailed view of a tension and buckle section of the band clamp of FIG. 13;

FIG. 15 is a detailed side, isometric view of the tension and buckle section of FIG. 14;

FIG. 16 is a detailed bottom, isometric view of the tension and buckle section of FIG. 15;

FIG. 17 is a top, isometric view of the tension and buckle section of FIG. 14;

FIG. 18 is a detailed side, cross-sectional view of the tension and buckle section of FIG. 15;

FIG. 19 is a detailed, perspective view of the tension and buckle section of FIG. 14;

FIG. 20 is a side view of the clamp and a tool for installing the clamp according to at least one embodiment of the present disclosure;

FIG. 21 is a detailed, top view of a tension and buckle section according to at least one embodiment of the present disclosure;

FIG. 22 is a detailed, isometric view of the tension and buckle section of FIG. 21;

FIG. 23 is a detailed, top view of a tension and buckle section according to at least one embodiment of the present disclosure;

FIG. 24 is a detailed, isometric view of the buckle according to at least one embodiment of the present disclosure;

FIG. 25 is a detailed, end view of the buckle according to at least one embodiment of the present disclosure;

FIG. 26 is a detailed, top view of the buckle of FIG. 25;

FIG. 27 is a detailed, side view of a tension and buckle section according to at least one embodiment of the present disclosure;

FIG. 28 is a detailed bottom, isometric view of the tension and buckle section of FIG. 27;

FIG. 29 is a top view of a band clamp according to at least one embodiment of the present disclosure;

FIG. 30 is a detailed top, isometric view of a first end of the clamp of FIG. 29B;

FIG. 31 is a top, isometric view of the clamp of FIG. 29B formed into a closed loop with a second end locked to the first end of the clamp;

FIG. 32 is a detailed top, isometric view of the joined first and second ends of the clamp of FIG. 31;

FIG. 33 is a detailed top, isometric view of an alternative embodiment of the band clamp of FIG. 32;

FIG. 34 is a top isometric view of a flat band clamp according to at least one embodiment of the present disclosure;

FIG. 35 is a top isometric view of the band clamp of FIG. 34, with a portion of the band folded to form part of a tension and buckle section;

FIG. 36A is a top isometric detailed view of the first end of the band clamp of FIG. 35;

FIG. 36B is a detailed cross-section view of the clamp of FIG. 36A;

FIG. 37A is a top isometric view of two band clamps of the type shown in FIGS. 36A-36C, according to at least one method of the present disclosure;

FIG. 37B is a top isometric view of the band clamp of FIG. 37A with a portion of the band folded to form part of a tension and buckle section;

FIG. 37C is a top detailed view of two interconnected band clamps according to at least one method of the present disclosure.

FIG. 38 is an isometric view of a plurality of band clamps show in FIG. 37B in a coiled state;

FIG. 39 is a flowchart according to at least one embodiment of the present disclosure;

FIG. 40 is a flowchart according to at least one embodiment of the present disclosure; and

FIG. 41 is a flowchart according to at least one embodiment of the present disclosure.

### DETAILED DESCRIPTION

Clamps configured to be pre-formed into a closed loop of a first diameter prior to installation and capable of being fixed or secured about a workpiece along a continuous finite range of smaller diameters are provided. The clamps beneficially enable the installation of a preformed or closed loop clamp on a variety of workpieces having different diameters, while being able to obtain a 360-degree seal with the workpiece. The clamps also beneficially include various features for staging the clamp in a closed loop configuration at or near a desired diameter, as will be described in detail below.

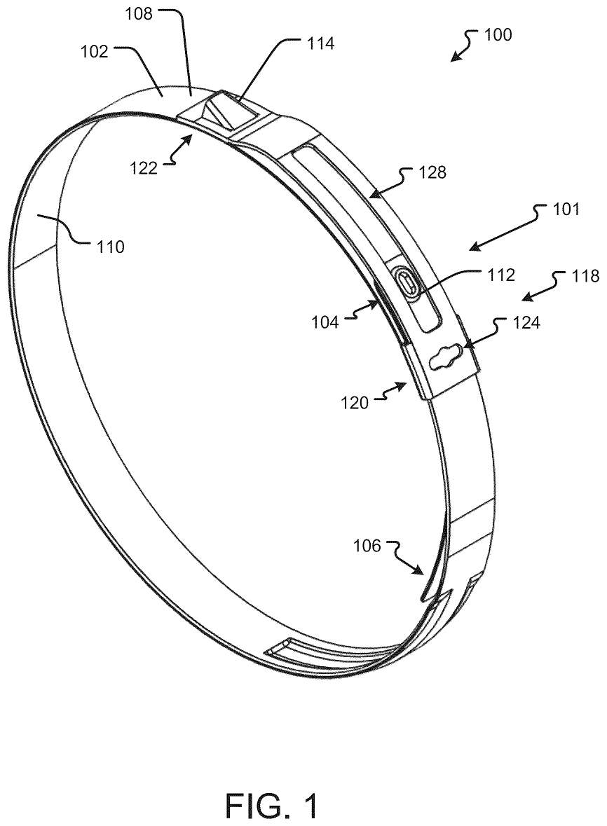

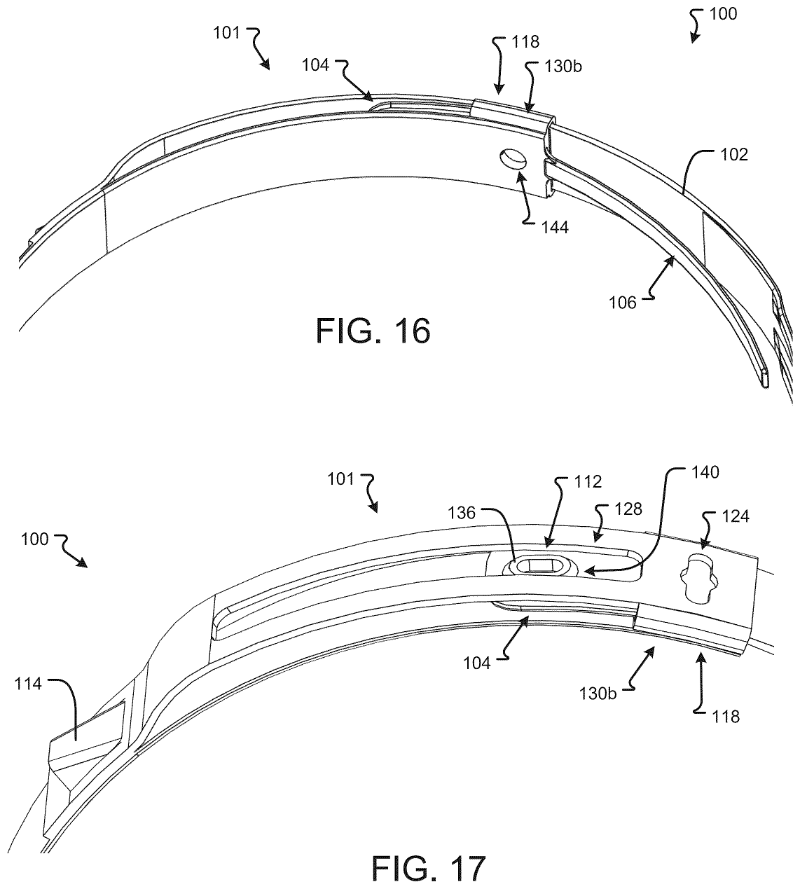

FIGS. 1-6 illustrate a clamp 100 having a variable diameter. Turning to FIG. 1 first, the clamp 100 is shown in an isometric view. The clamp 100 includes a band 102 extending from a first band end 104 to a second band end 106. The band 102 has an outer surface 108 and an inner surface 110. A first receiver 112 is positioned on the outer surface 108 proximate the first band end 104 and a second receiver 114 is positioned at a first end 120 of a tension and buckle section 101. A buckle 118 is positioned at the second or opposite end 122 of the tension and buckle section 101. As will be discussed in more detail in FIG. 16, the first receiver 112 and the second receiver 114 are used by a tool 116 to tighten the clamp 100.

The tension and buckle section 101 is fixed to the outer surface 108 of the band 102 at each of the first end 120 and the second end 122. The tension and buckle section 101 may be a piece separate from the band 102, though the tension and buckle section 101 may also be formed from the band 102. In the illustrated embodiment of FIGS. 1-6, the tension and buckle section 101 is fixed to the band 102 by welding. In other embodiments, the tension and buckle section 101 may be fixed to the band 102 by, for example, adhesion, integrated mechanical locks such as a tab and slot lock, a friction fit (e.g., between a protrusion and receiver), or the like. The tension and buckle section 101 has a width substantially equal to or less than a width of the band 102 such that the tension and buckle section 101 and the band 102 can together fit within, for example, a groove of a workpiece such as a CV boot.

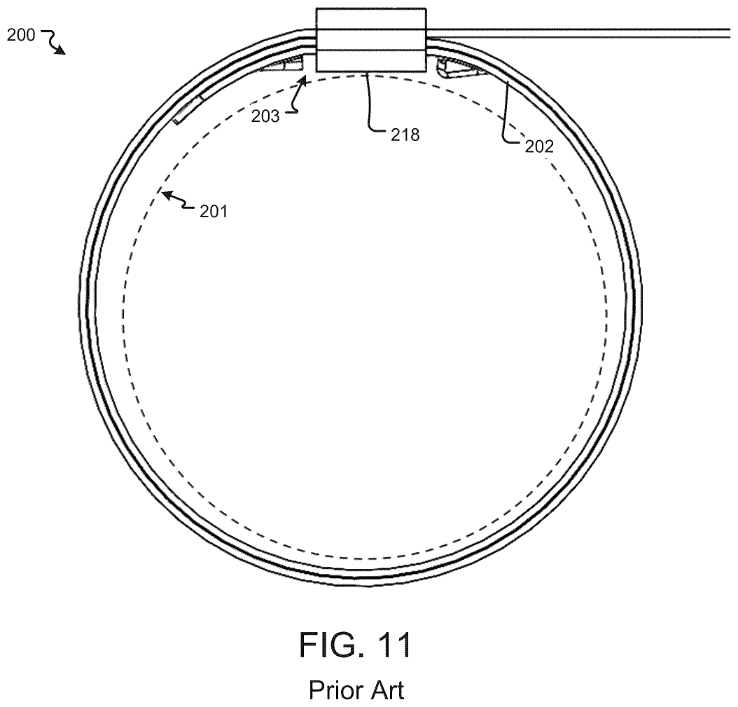

The tension and buckle section 101 includes the buckle 118, which includes an opening 124 on the inside surface at the second end 122. The tension and buckle section 101 also includes the second receiver 114 at the second end 122, and an elongate slot 128 that extends from the first end 120 to the second end 122 (e.g., parallel to a longitudinal axis of the band as defined between the first band end 104 and second band end 106). As shown, when the band 102 is preformed into a closed loop, the first receiver 112 is positioned in the slot 128 and is movable within the slot 128 (as shown and discussed in more detail in FIGS. 10 and 11). Thus, at its largest diameter or circumference, the receiver 112 is located proximate the second end 122. By moving the first receiver 112 within the slot 128, a diameter or circumference of the clamp 100 increases or decreases accordingly. Once the clamp 100 is at a target diameter, e.g., properly tightened about a workpiece, a tool, for example the tool 116 illustrated in FIG. 16, may activate and lock the buckle 118 to secure the diameter of the clamp 100 and achieve a desired retained force. More specifically, the tool moves a punch and deforms the band 102 at the opening 124 to lock the clamp 100 at the target diameter, as will be discussed in more detail in FIG. 16.

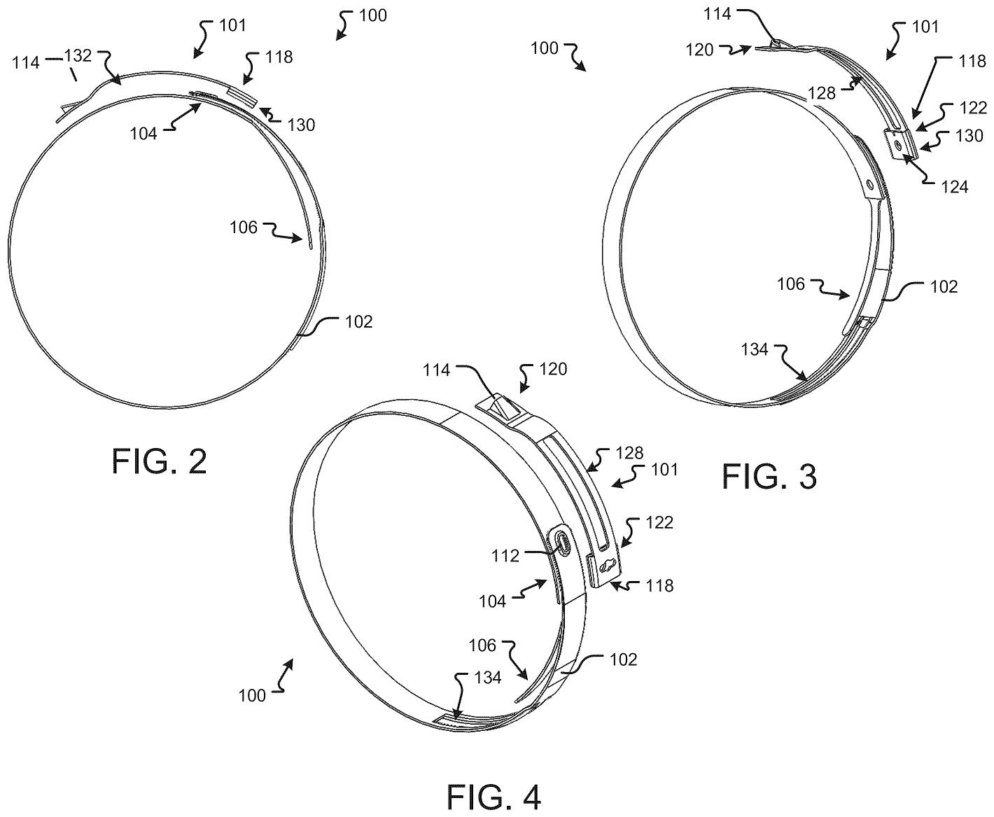

Turning to FIGS. 2-6, an exploded, side view; an exploded, perspective view; another exploded, perspective view; and a perspective view, respectively, are illustrated. As shown in FIGS. 3-6, the band 102 includes a depression 134 for receiving the second band end 106. The depression 134 enables the inner surface 110 of the band 100 to be flush and form a 360-degree seal with an outer surface of a workpiece. In other words, the second band end 106 may be positioned within the depression 134 such that the second band end 106 is in line or flush with the inner surface 110. If the second band end 106 is not positioned in the depression 134, the second band end 106 would be positioned between the inner surface 110 and the outer surface of the workpiece and form a high point or high area, thereby preventing the 360-degree seal between the inner surface 110 of the band 102 and the outer surface of the workpiece from forming. Similarly, the buckle 118 positioned on the outer surface 108 of the band 102 also enables a continuous, 360-degree seal to be formed between the band 102 and the workpiece. As previously described, the band 102 forms a coil or closed loop such that the first band end 104 is positioned between the buckle 118 and the band 102. Such configuration enables the band 102 to form the seal between the workpiece and the clamp 100 as the buckle 118 is positioned on top of (or on the outer surface 108) of the band 102.

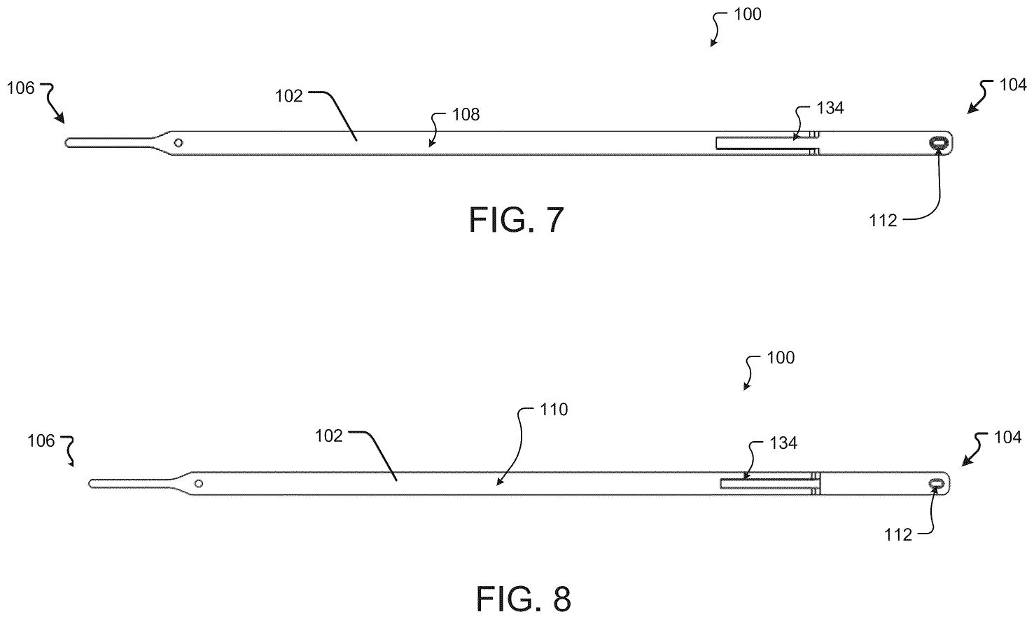

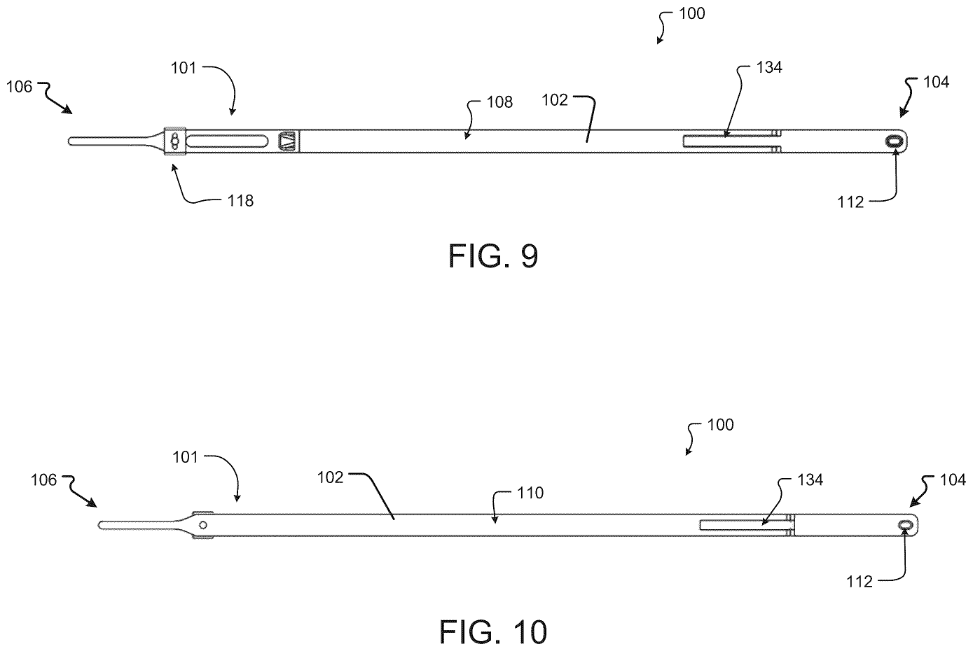

FIGS. 7 and 8 illustrate the band 102 of FIGS. 2-6, without a buckle and tension section 101. The band 102 is flat, as initially stamped or formed. FIG. 7 is a top view, with the upper surface 108 shown. FIG. 8 is a bottom view, with the channel 134 shown. FIGS. 9 and 10 illustrate the band 102 with the buckle and tension indicator 101 affixed to the band 102. FIG. 9 is a top view, FIG. 10 is a bottom view.

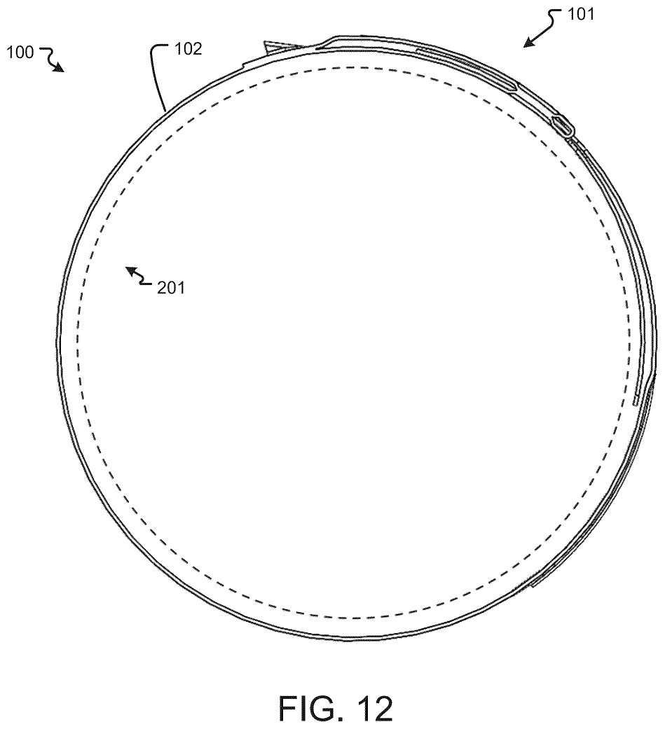

As shown in FIG. 11, in conventional clamps 200 with diameter reduction, a conventional buckle 218 rests on a surface of a workpiece 201 (represented by a dashed line) and forms a step and leak path 203 between a band 202 and the buckle 218. Such step and leak path 203 may prevent a seal from being formed between the clamp 200 and the workpiece 201. Conventional clamps 200 may include one or more dimples to reduce the leak path 203, however, such dimples do not enable a continuous seal around the workpiece 201. In contrast, as shown in FIG. 12, the clamp 100 according to embodiments of the present disclosure beneficially enables a seal to be formed between the clamp 100 and the workpiece 201 because the buckle 118 is formed on top of the band 102.

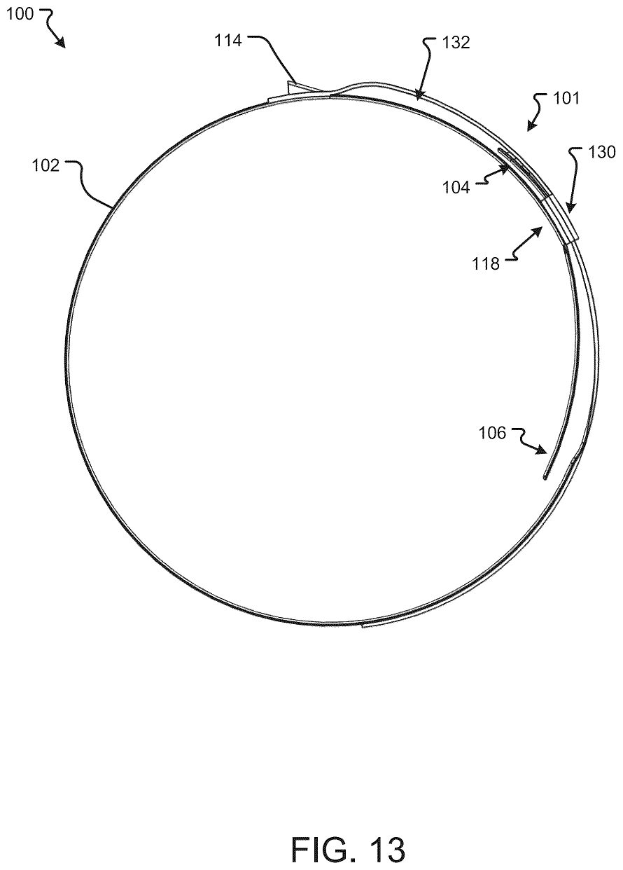

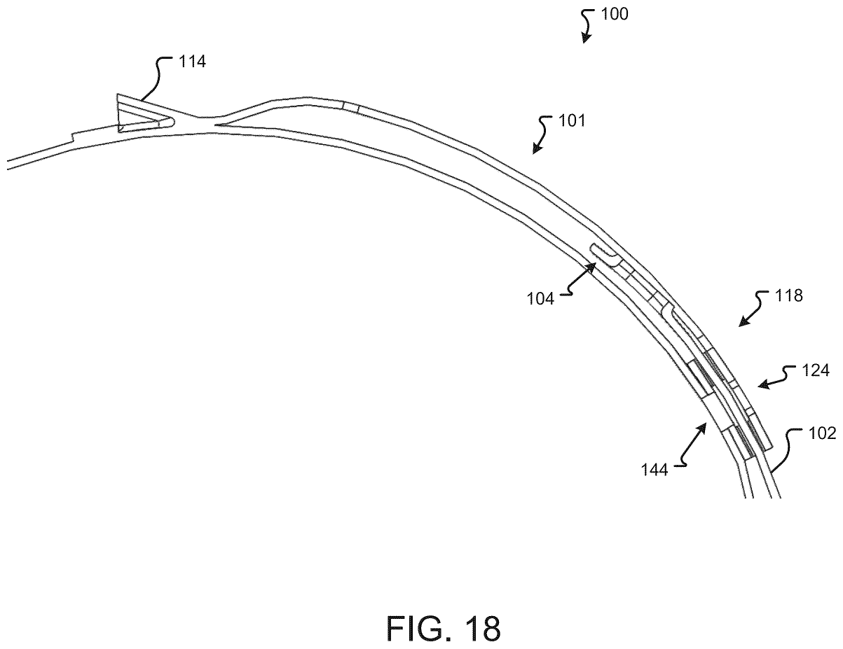

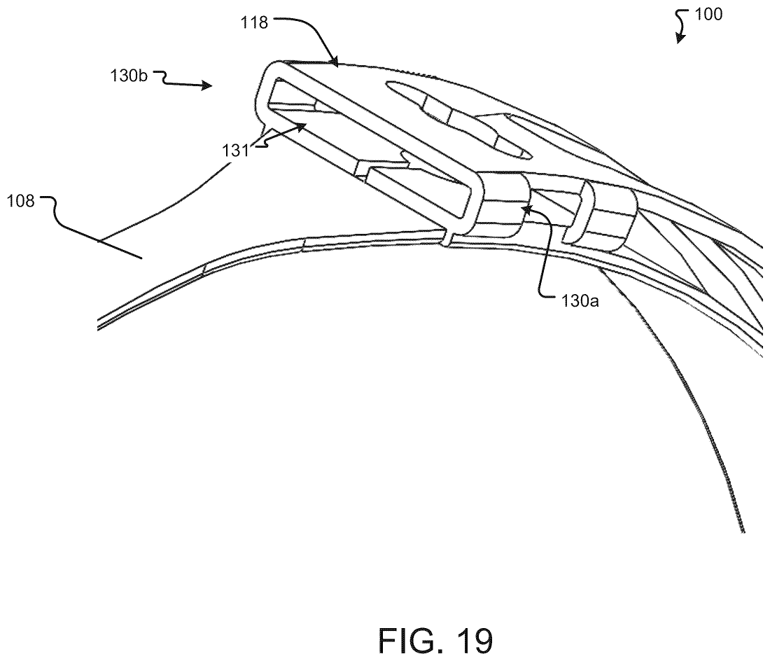

Turning to FIGS. 13-19, a side view, top view; a side, detailed view; a bottom, perspective view; a top, perspective view; a side, cross-sectional view; and another perspective view of the clamp 100 are respectively shown. The buckle 118 further includes at least one tab 130 located at the front end of the slot 128 as best seen in FIGS. 17 and 19. The tab 130 has two legs 130a and 130b that are folded to define side walls and base portions of the buckle 118 and define an opening 131 (shown in FIG. 19) through which the first band end 104 passes. The base portions of the legs 130a and 130b abut the upper surface 108 of the first band end 104 when the band is pre-formed into a closed loop, as seen in FIG. 15, and defines a space 132. The space 132 spans at least a length of the slot 128.

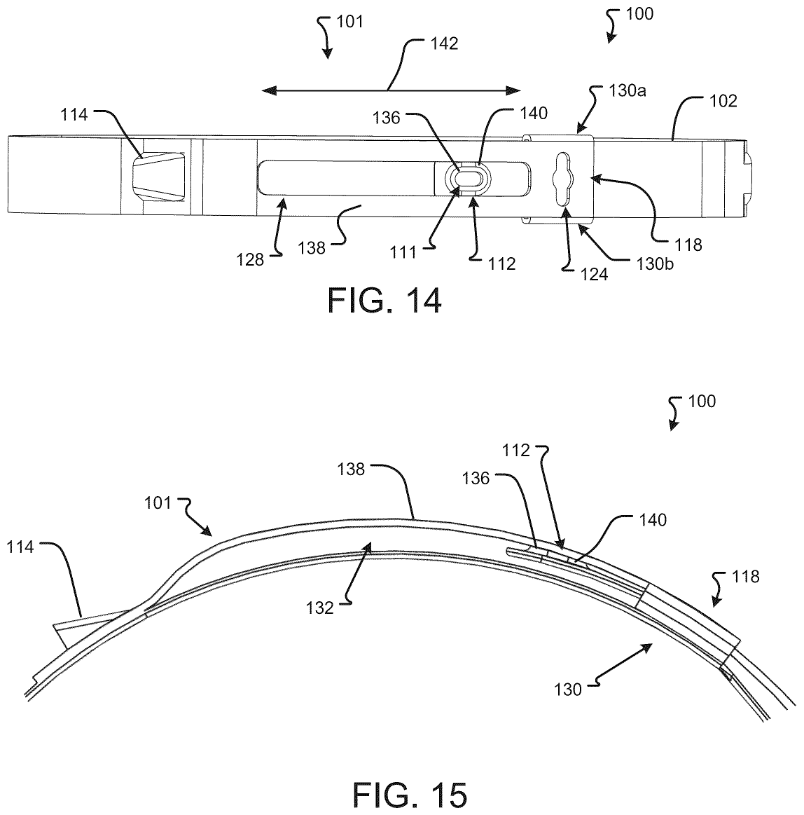

Upon the band 102 being formed into a closed loop, the first receiver 112 is positioned in and is movable within the slot 128. As shown, the first receiver 112 is a protrusion 136 that extends from the outer surface 108 of the band 102 at the first band end 104. In the illustrated embodiment, the protrusion 136 forms an aperture 111 that extends through the band 102. Alternatively, the protrusion 136 may form a depression. In still other embodiments, the first receiver 112 may be any edge, depression, surface, and/or aperture that enables a complimentary tool to engage with to reduce a diameter of the band 102. The protrusion 136 may be oval in shape when viewed from the top, as shown in FIG. 14. Such oval shape enables a hook of the tool 116 to easily contact and grab the first receiver 112 during tensioning of the clamp 100. It will be appreciated that the protrusion 136 may be any shape when viewed from the top such as, for example, circular, square, rectangular, etc. In other embodiments, the protrusion 136 may be, for example, one or more walls, one or more lips, one or more edges, any combination of walls, lips, or edges, or any other feature such that the tool 116 can grasp or grab to push and pull against. Further, the protrusion 136 may have a width less than a width of the slot 128 such that the protrusion 136 can slide within the slot 128 in the directions of the arrow 142. As the protrusion 136 moves or slides within the slot 128, the first end 104 also moves, thereby increasing or decreasing a diameter of the clamp 100. In some embodiments, the diameter of the clamp 100 may be reduced by about half an inch from an initial diameter of the clamp 100. It will be appreciated that in other embodiments, the clamp 100 may be reduced by more than half an inch from the initial diameter of the clamp 100.

In at least one embodiment, the protrusion 136 has a width that enables the protrusion 136 to be free-fitting in the slot 128 such that there is no interference between the protrusion 136 and the slot 128 and such that the protrusion 136 can slide within the slot 128 while remaining aligned within the slot 128. In some embodiments, the protrusion has a width that is 0.050″ less than the width of the slot 128. It will be appreciated that in other embodiments, the protrusion 136 can have a width that is greater than or less than 0.050″ less than the width of the slot 128. As shown, the protrusion 136 also has a height equal to about a thickness of the tension and buckle section 101 such that the protrusion 126 extends into the slot 128 and does not extend past an outer surface 138 of the tension and buckle section 101. It will be appreciated that in other embodiments, the protrusion 136 may have a height greater than or less than a thickness of the buckle 118. In some embodiments, the protrusion 136 can be moved underneath and out of the buckle 118 to remove the first band end 104 of the band 102 from the buckle 118 such that the clamp 100 can be wrapped around a workpiece. The first band end 104 and the protrusion 136 can then be pushed into the buckle 118 when the clamp 100 is positioned over the workpiece.

As also shown, the protrusion 136 includes a lip 140 formed between the protrusion 136 and the outer surface 108 of the band 102. The lip 140 aids in preventing twisting of the band 102 during installation of the band 102. The lip 140 (or protrusion 136) may also contact edges of the slot 128 so as to keep the band 102 centered and aligned with the slot 128. The lip 140 and/or protrusion 136 may also beneficially retain and hold the first receiver 112 so as to prevent the clamp 100 from opening up during, for example, shipping and/or handling of the clamp 100 prior to installation. It will be appreciated that in some embodiments, the clamp 100 alternatively may be formed and/or shipped as a flat band or tie (as shown in FIGS. 7-10) that is coiled by a user such as, for example, an operator during assembly. Additionally, the lip 140 and the protrusion beneficially strengthens the tensioning area and provides a large target for the tool 116 to grasp.

Turning to FIGS. 16 and 17, the band 102 also includes a band aperture 144 opposite the opening 124 of the buckle 118. During installation, a punch punches the band 102 through the opening 124 such that the band 102 is deformed and pressed into the band aperture 144 to lock the band 102 in place. In other embodiments, the clamp 100 may be tensioned and locked using a tool configured to attach to or hold the buckle 118 while moving the first receiver 112 to tension the clamp 100. The clamp 100 can then be punched or otherwise secured at the first receiver 112. In such embodiments, the clamp 100 may not include, for example, the aperture. In still other embodiments, the clamp 100 may be locked by, for example, welding or using a mechanical lock, adhesion, and/or lip lock.

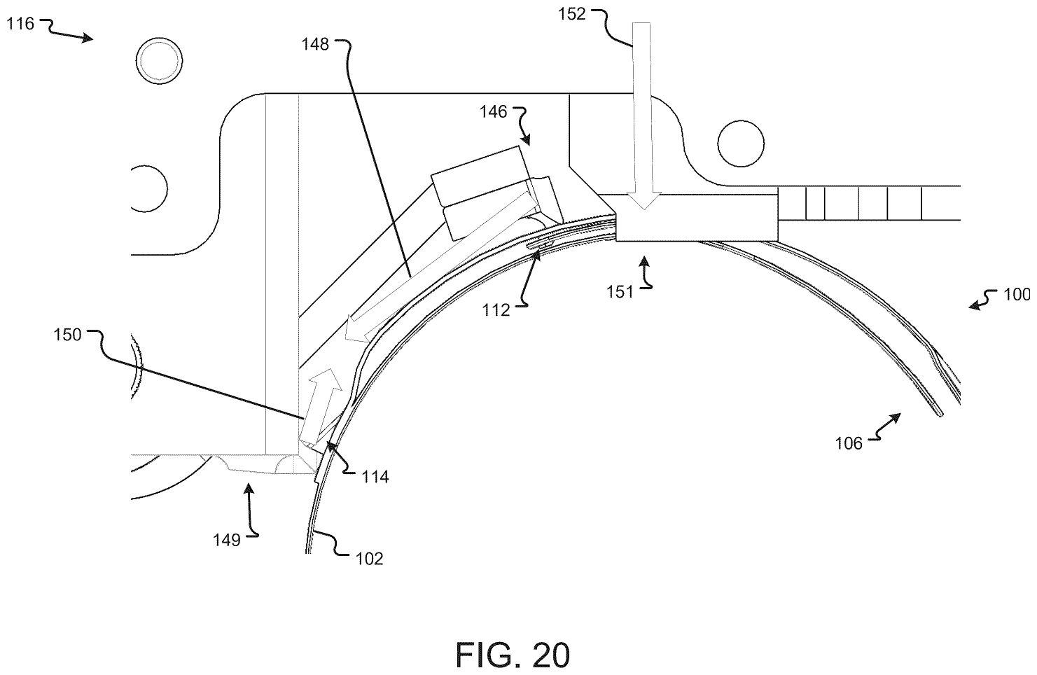

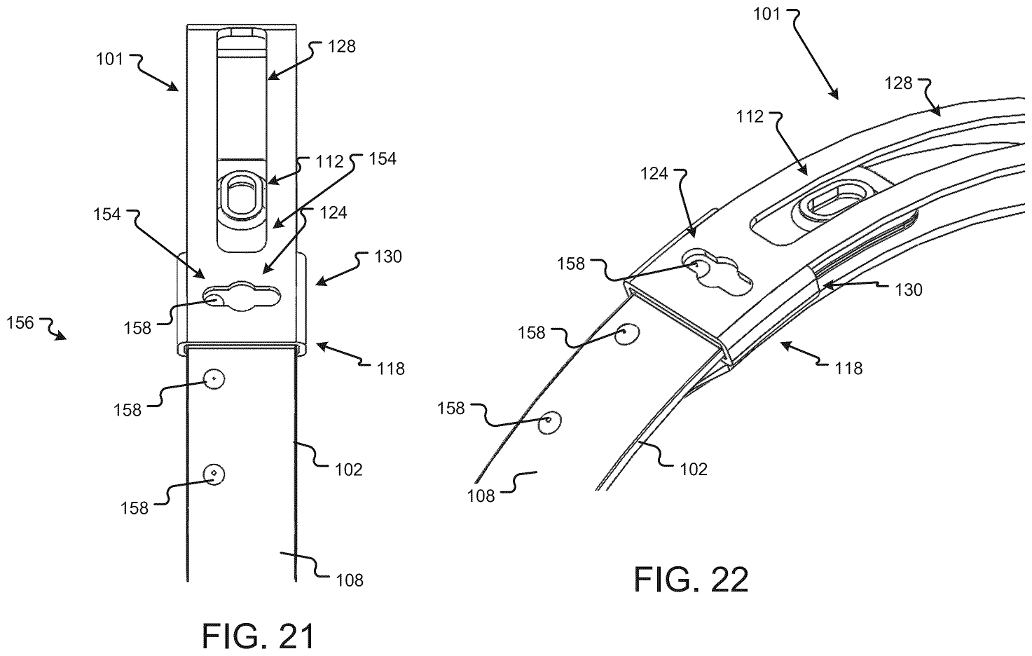

Turning to FIG. 20, the tool 116 is shown and illustrates an installation of the band 102. The tool 116 includes a first hook 146 configured to hook the first receiver 112 and move the first receiver 112 in the direction of arrow 148. A second hook 149 is configured to hook the second receiver 114 and move the second receiver 114 in the direction of arrow 150. The first hook 146 and the second hook 149 can tension the clamp 100 to a desired tension, then a punch 151 of the tool 116 can punch the buckle 118 and the band 102 (illustrated for reference as arrow 152) through the opening 124 to deform the band 102 into the band aperture 144, thereby locking the band 102 in place. Alternatively, one hook may remain in a fixed position while the second hook moves relative to the first hook. Though one opening 124 and one band aperture 144 are shown, it will be appreciated that in other embodiments the clamp 100 may include more than one opening 124 and more than one band aperture 144 such that the clamp 100 can be punched and locked in more than one location on the clamp 100. Additionally or alternatively, the clamp 100 may be locked in other ways such as, for example, the buckle 118 may be crimpled against the band 102 to lock the band 102 in place. Reference will now be made to FIGS. 21-28 where various features of the clamp 100 are shown. It will be appreciated that the clamp 100 may include any number and/or combination of the features described. It will also be appreciated that in some embodiments, the clamp 100 may not include any of the features described in FIGS. 21-28.

Turning to FIGS. 21-22, a detailed top view and a detailed perspective view of the clamp 100 are respectively shown. As shown, the opening 124 includes at least one laterally extending slot or wing 154. In the illustrated embodiment, the opening 124 includes two wings 154 opposite each other, though it will be appreciated that in other embodiments the opening 124 may include one wing, two wings, or more than two wings. The wing(s) 154 are configured to receive at least one raised feature 156. As shown, the at least one raised feature 156 includes three raised features, though it will be appreciated that in other embodiments, the at least one raised feature 156 may include one raised feature, two raised features, or more than two raised features. As shown, the at least one raised feature 156 comprises at least one protrusion or outwardly extending dimple 158. Though one dimple 158 is shown in a corresponding wing 154, it will be appreciated that a pair of dimples 158 can be received in a pair of wings 154. The dimple(s) 158 may be received in a corresponding wing 154 to hold the clamp 100 at a temporary position or diameter. In other words, the dimple(s) 158 may be used to “stage” the clamp 100 at or near a desired target diameter until the clamp 100 is tensioned and locked. Thus, a user does not need to hold the clamp 100 at or near the desired target diameter. This is beneficial as, for example, multiple bands can be “staged” and installed at the same time. Alternatively, the dimple(s) could be on an inside surface of the buckle 118 and the band 102 may have holes or apertures that receive the dimple(s).

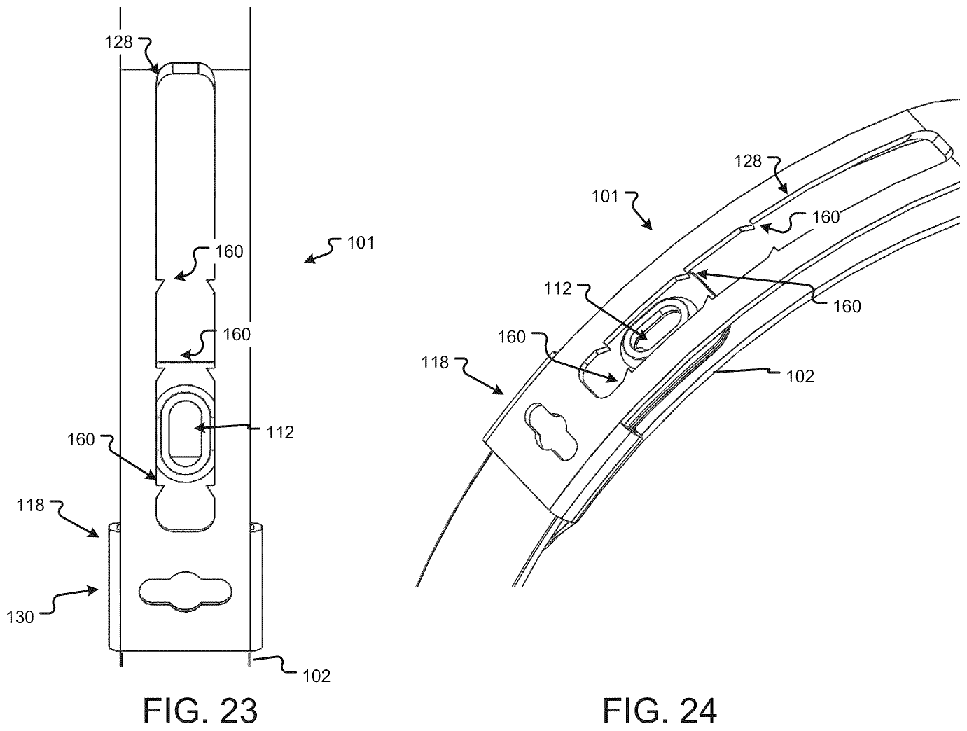

Turning to FIGS. 23-24, a detailed top view and a detailed perspective view of the clamp 100 are respectively shown. As shown, the slot 128 includes one or more sets of edges or hooks 160 located on opposite sides of slot 128. In the illustrated embodiment, the one or more sets of hooks 160 include three sets of hooks 160, though it will be appreciated that in other embodiments the one or more sets of hooks 160 may include one set of hooks, two sets of hooks, or more than two sets of hooks. Further, the set of hooks 160 include a pair of hooks with each hook positioned on opposite sides of the slot 128 in the illustrated embodiment. In other embodiments, the set of hooks 160 may include one hook, two hooks, or more than two hooks located on one side of the slot 128. When the first receiver 112 is positioned in a corresponding set of hooks 160, the set of hooks 160 may temporarily hold the first receiver 112 in place. Similarly to the at least one raised feature 156 described above, the set of hooks 160 may be used to “stage” the clamp 100 at or near a desired target diameter until the clamp 100 is tensioned and locked. Thus, a user does not need to hold the clamp 100 at or near the desired target diameter. It will be appreciated that in some embodiments, the one or more hooks 160 may extend into the band 102. In such embodiments, the one or more edges or hooks 160 may extend into corresponding notches formed in the band 102. In other embodiments, the protrusion 126 may also have one or more edges or hooks 160.

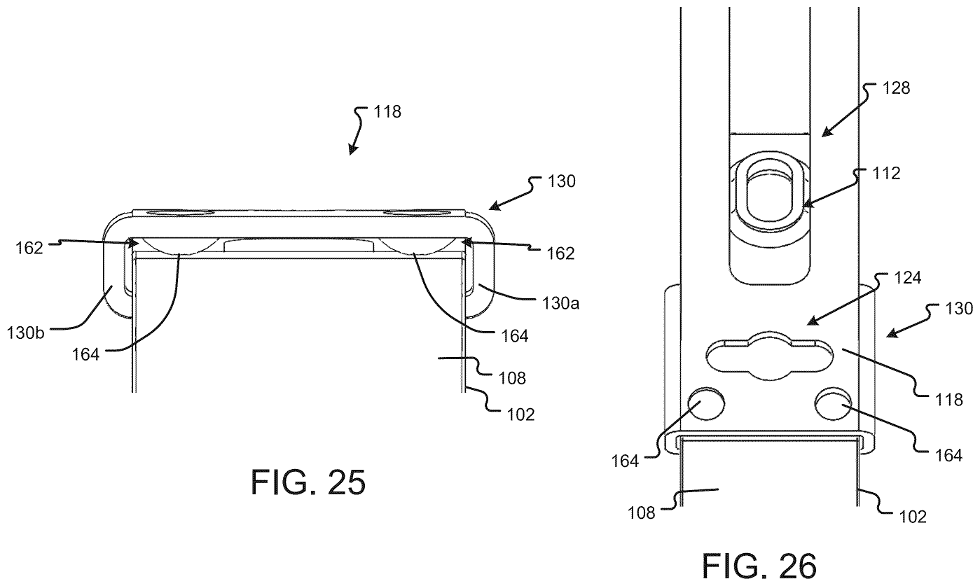

Turning to FIGS. 25-26, a detailed front view and a detailed top view of the clamp 100 are respectively shown. As shown, the buckle 118 includes at least one friction feature 162. The at least one friction feature 162 includes two dimples 164 extending from the buckle 118 near the at least one tab 130. The two dimples 164 are configured to contact the outer surface 108 of the band 102 at the first band end 104. the friction created by the dimple(s) 164 contacting the band 102 may also hold the clamp 100 at or near a target diameter to “stage” the clamp 100 before tensioning and locking the clamp 100. In some embodiments, one or more apertures can be formed on the band 102 and may be configured to capture or receive corresponding dimple(s) 164 to stage the clamp 100.

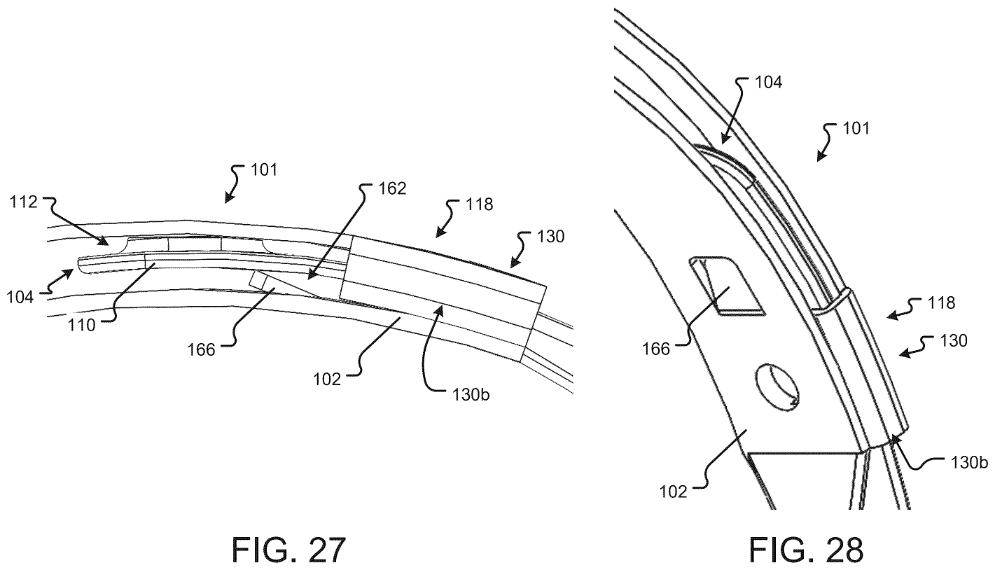

Turning to FIGS. 27-28, a detailed side view and a detailed perspective view of the clamp 100 are respectively shown. As shown, the band 102 includes the at least one friction feature 162. In the illustrated embodiment, the at least one friction feature 162 includes a ramp 166 that extends from the band 102 and contacts the inner surface 110 of the band 102 as the first band end 104. As described above, the friction created by the ramp 166 contacting the band 102 may also hold the clamp 100 at or near a target diameter to “stage” the clamp 100 before tensioning and locking the clamp 100.

Additionally or alternatively to the features described above, the clamp 100 may also have a spring force such that force may be applied to the clamp 100 to open the band 102. In other words, the clamp 100 may be biased to a closed or coiled position. Such spring force may make installation easier as once the clamp 100 is opened and positioned over a workpiece, the clamp 100 will move back to its closed or coiled position and hold itself on the workpiece.

The friction feature 162 may also beneficially enable a higher retained force of the clamp 100 as the friction feature 162 does not let the clamp 100 move to a completely relaxed position. By holding the clamp 100 in place using the friction feature 162, the retained or captured force in the clamp 100 may be higher than a conventional clamp used for, for example, securing CV boots to a CV joint. It will be appreciated that the clamp 100 may be used in any application or industry.

The clamp 100 may be formed of any solid material such as, for example, metal, metal alloys, plastics, etc. For example, the clamp 100 may be formed from stainless steel, carbon steel, galvanized carbon steel, titanium, nickel alloys, etc. It will be appreciated that the clamp 100 may be formed of the same material or may be formed from a combination of materials. For example, the buckle 118 may be a different material than the band 102 (or may be the same material). At least a portion of the clamp 100 may also be tempered. For example, the buckle 118 may be tempered, or may be tempered to a different degree than the band 102. In such examples, the buckle 118 may be tempered such that the punch can deform the band 102 more easily. The clamp 100 may also have any width and/or thickness, and may have different widths for different applications. For example, the clamp 100 may be sized to fit within a groove of a CV boot.

The clamp 100 beneficially enable a larger diameter reduction and a continuous variable diameter compared to conventional clamps used for, for example, securing CV boots to CV joints. Whereas multiple conventional clamps are needed to accommodate different sized CV boots, one clamp 100 can accommodate a range of different sized CV boots (or any workpiece). Further, the clamp 100 has a low profile due to the buckle 218 being slightly spaced from and raised from the band 102, 202. Such low profile may prevent the clamp 100 from snagging or getting caught on other components. Further, because the clamp 100 is simply tensioned and locked, installing the clamp 100 can be automated. In other words, the clamp 100 does not require any extra steps such as for example, cutting a tail of the band 102, 202, and thus, can be adapted to an automation process. Additionally, the staging features such as the spring force in the band 102, the raised feature 156, the set of hooks 160, and/or the friction feature 162 may facilitate installation and/or aid in automating the installation of the clamp 100 by staging the clamp 100 at or near the target diameter as the clamp 100, for example, moves down an assembly line. The staging features may also be beneficial in staging the clamp 100 for transferring the clamp 100 during, for example, shipping.

The clamp 100 also provides the benefit of being easily checked for proper installation as the band 102 can be visually checked for a dimple formed at the opening 124 after the band 102 is punched. Further, the clamp 100 beneficially retains more force than conventional bands as the clamp 100 can be held in place prior to tensioning and does not move to a fully relaxed state.

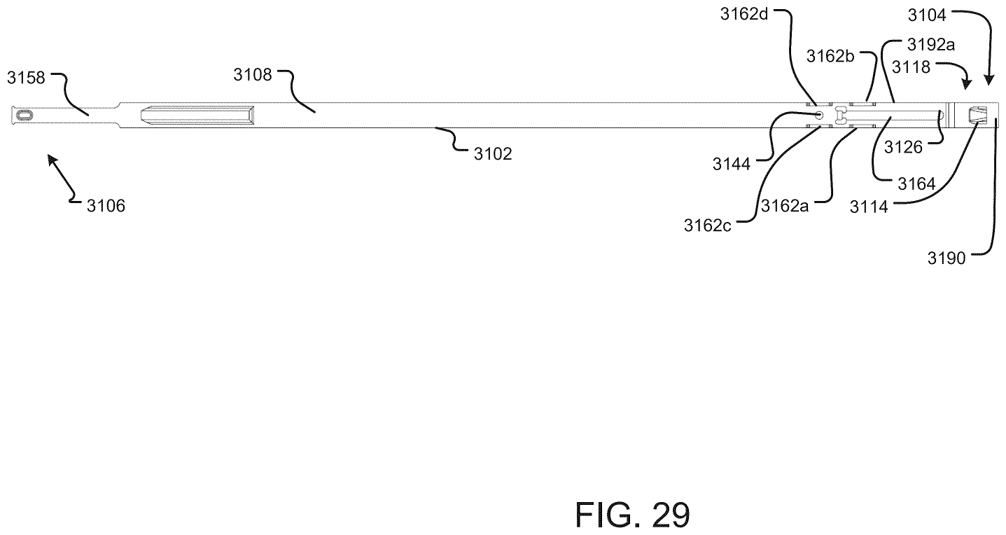

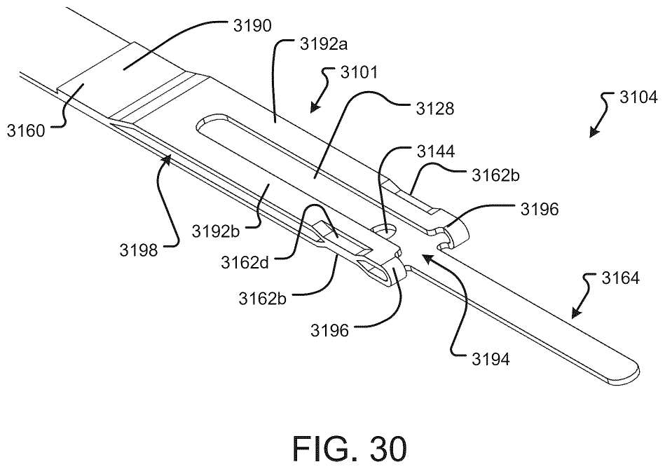

Turning to FIGS. 29-32, another embodiment of a band clamp according to the present disclosure is illustrated. As shown, the band clamp 3100 includes a band 3102 that extends from a first band end 3104 to a second band end 3106 and has an outer surface 3108 and an inner surface 3110. In the illustrated embodiment, the clamp 3100 may be formed from a single piece of material with the tension and buckle section 3101 made by an appropriately shaped cut proximate the first band end 3104 and a portion of the material folded over onto the band 3102. The band 3102 is shown with the tension and buckle section 3101 unfolded in FIG. 29 and folded over onto the outer surface 3108 of the band 3102 in FIGS. 30-32. More particularly, a U-shaped cut 3126 is made along a length of the band 102 proximate but spaced from the first band end 3104 leaving a land 3190 between the cut and the end of the first band end 3104. The cut may be made by a knife, laser or by other methods known to those of skill in the art. The cut 3126 is not limited to a U-shape but may be other shapes that facilitate folding of the band to form a slot to receive the second band end. A receiver 3114 may be formed in the land 3190. When folded, the land 3190 is secured to the outer surface 3108 of the band 3102 and two arms 3192a and 3192b resulting from the cut 3126 form slot 3128. The land 3190 may be welded to the outer surface 3108 of the band 3102 at a first connection point 3160 or connected to the band 3102 in any way manner to withstand tensioning forces. Second connection points 3162, shown in FIG. 30, may also be utilized. Here, the connections are made by welding.

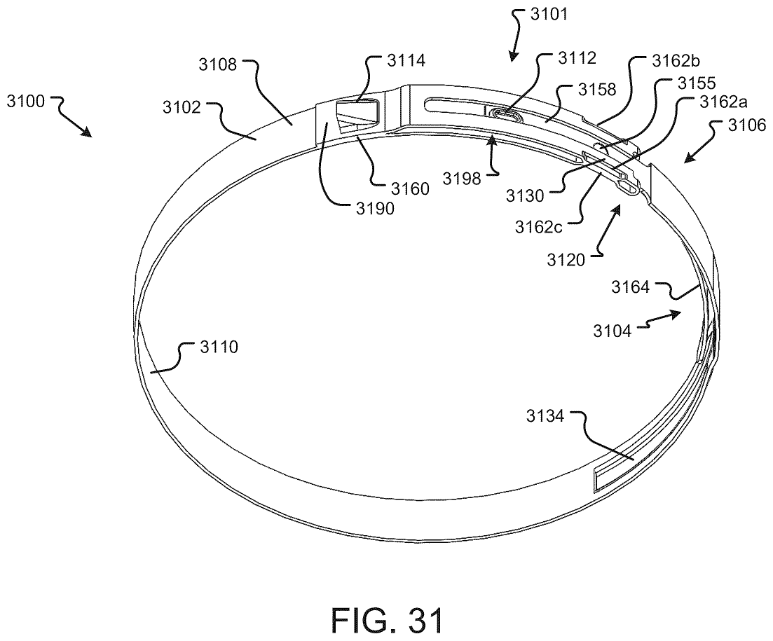

As also shown in FIG. 31, the cut 3126 allows the band 3102 and the tension and buckle section 3101 to be formed from a single piece of band material rather than forming the tension and buckle section from a separate piece of material. In addition, a tail 3164 at the first band end 3104 is also created. The tail 3164 may be removed from the band or, alternatively may be received in a depression or groove 3134 formed at the bottom surface 3110 of the band 3102 proximate the second band end 3106 when the band is formed into a closed loop as seen in FIG. 31. Here, the depression or groove 3134 may be formed by a stamping process in which case the upper surface of the band 3108 will have an outwardly extending ridge or bump. Alternatively, the groove 3134 may be cut into the band and there would be no ridge formed on or protruding from the upper surface 3108. The engagement of the tail 3164 within the groove 3134 assists in maintaining alignment of the first band end 3104 and second band end 3106 as band ends are joined together and the depression 3134 provides a recess or pocket for the tail 3164 such that the tail 3164 is recessed relative to the inner surface 3110 and does not interfere or prevent the inner surface 3110 of the band from forming a flush interface with the outer surface of the workpiece being clamped.

A tongue 3158 positioned at the second band end 3106 is configured to be received in the slot 3128 of the buckle 3118. The tongue 3158 may be sized to have a width less than an overall width of the band 3102 such that the second band end 3106 can be received in the slot 3128 of the tension and buckle section 3101. The tongue 3158 may also be sized to have a width that creates an interference such that the tongue 3158 can be inserted into the slot 3128 with force and also held within the slot due to interference. The interference fit may be accomplished in a variety of ways as will be appreciated by those of skill in the art upon review of this disclosure. For example. The tongue 3158 may be slightly wider than the opening 3194 formed by folds 3196. Alternatively, the height of the gap 3198 formed between the upper surface 3108 of the band and the folded over arms 3192 may be slightly less than the thickness of height of the tongue 3158. Further still, staging features as described herein in connection with FIGS. 21-28 may be used, alone or in combination, to temporarily secure the tongue 3158 inside the slot 3128. In preferred embodiments, the tongue 3158 and slot 3128 are configured to permit the tongue 3158 to be removed from the slot and re-inserted into the slot 3128 without damage to the band. This allows an installer to uncouple the tongue 3158 from the slot 3128 and reposition the band relative to a workpiece and then re-couple or re-stage the band by securing the tongue within the slot.

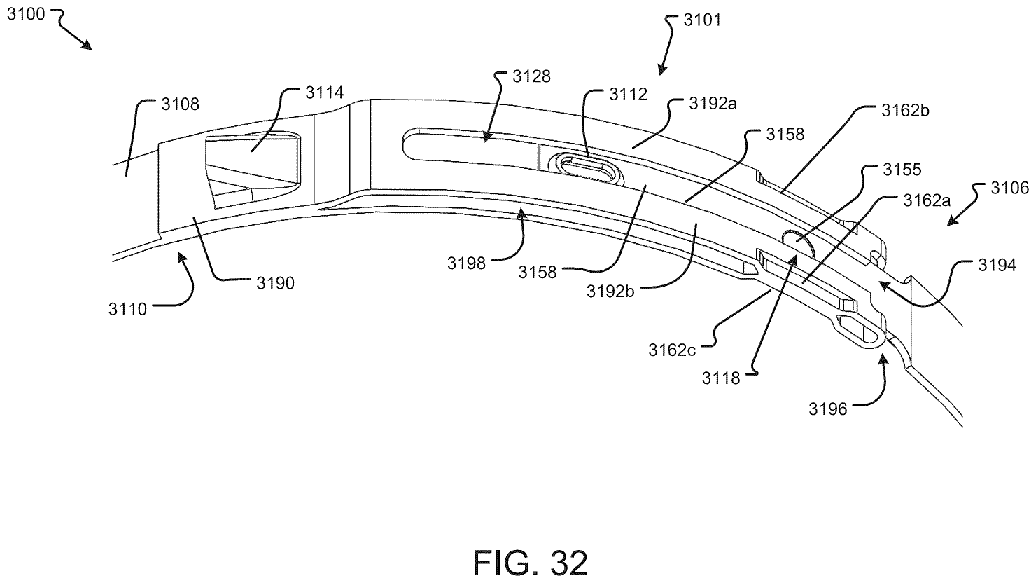

As best shown in FIGS. 29 and 30, the band may include an aperture 3144 to assist in locking the band clamp in connection with a punch operation. The aperture 3144 is located generally proximate the first band end 3104 at a location within the boundaries of the tension and buckle section 3101 after the arms 3192a and 3192b are folded over. FIGS. 31 and 32 illustrate the band clamp 3100 after a punch operation. Reference number 3155 depicts a depression or dimple formed in the tongue 3158 following a punch operation. Although not seen in the figures, the dimple 3155 extends into the aperture 3144 to secure the tongue 3158 relative to the band. A punch drives a portion of the tongue 3158 into the aperture 3144 to lock the circumference of the band.

FIGS. 29-32 also illustrate four indentations formed along both sides of the band. As seen in FIG. 29, a first pair of two indentations 3162a and 3162c are formed on one side of the band and a second pair of two indentations 3162b and 3162d are formed on the opposite side. When the arms 3192a and 3192b are folded over, the indentations of each pair meet or abut as seen in FIG. 30. As also seen in FIG. 30, the indentations protrude or extend the outer surface 3108 of the band and when the indentations abut they form a spacer that that separates the arms 6192a and 6192b from the outer surface 3108 of the band and forms a gap 3198 between the arms and the outer surface of the band. The abutting indentations also provide connection points where the arms of the tension and buckle section may be welded to the band.

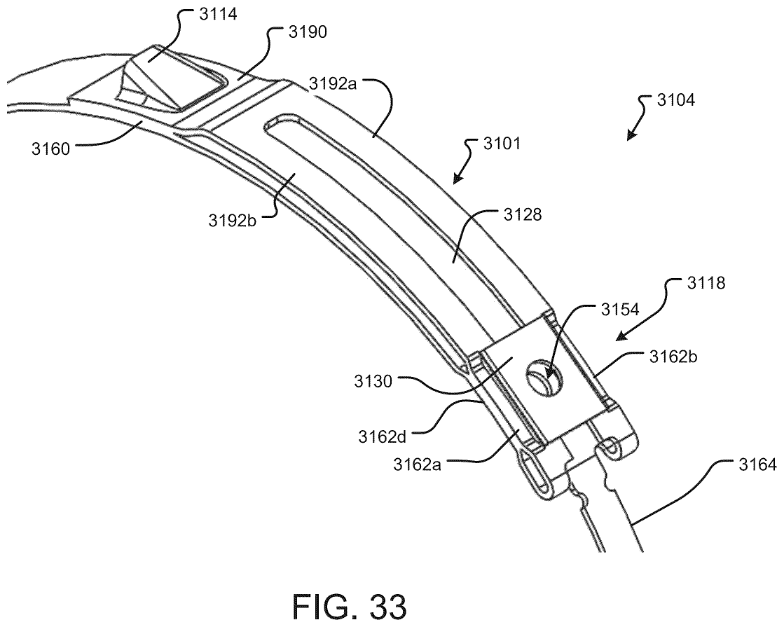

FIG. 33 illustrates an alternative locking arrangement for the embodiment shown in FIGS. 29A-32. Here, a guide plate 3130 is secured to the arms 3192a and 3192b and across the slot 3128. The guide plate includes aperture 3154. Aperture 3154 aligns with aperture 3144 to receive a punch

The band clamp 3100 may also be formed of any solid material, such as metal, metal alloys, plastics, etc. For example, the clamp 3100 may be formed from stainless steel, carbon steel, galvanized carbon steel, titanium, nickel alloys, etc. It will be appreciated that the clamp 3100 may be formed of the same material or may be formed from a combination of materials. For example, the buckle 3118 may be a different material than the band 3102 (or may be the same material). At least a portion of the clamp 3100 may also be tempered or portions of the clamp 3100 may be tempered to different degrees. For example, the tab 3130 may have a different temper but the buckle 3118 and band 3102 should have the same temper. The clamp 3100 may also have any width and/or thickness and may have different widths for different applications. For example, the clamp 3100 may be sized to fit within a groove of a CV boot.

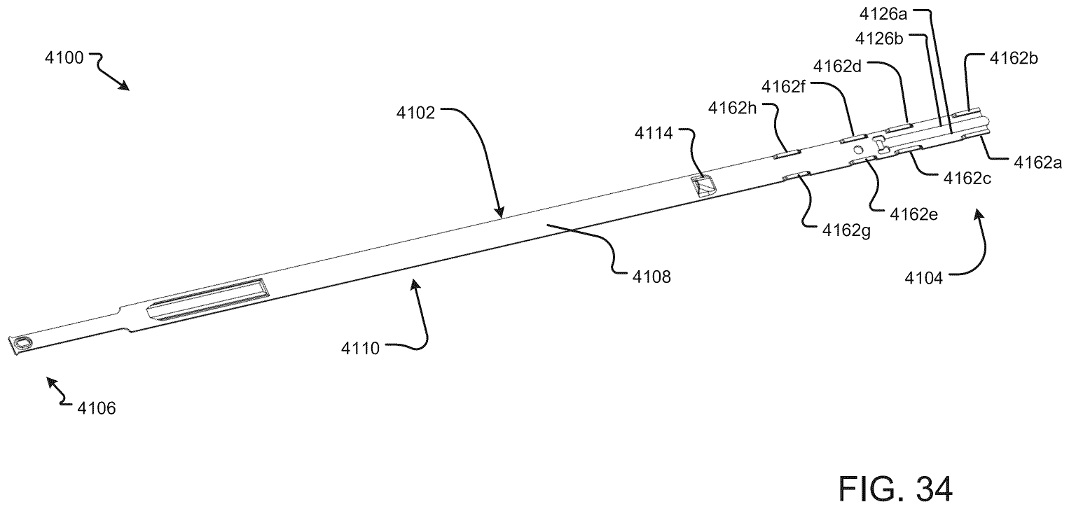

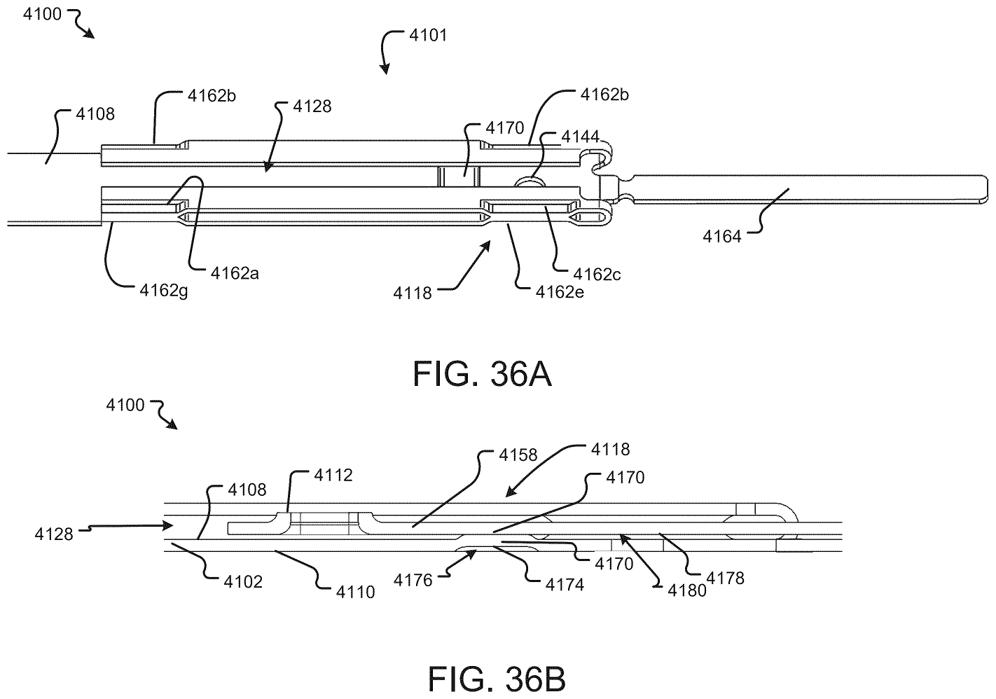

Turning to FIGS. 34, 35, 36A and 36B, an embodiment of a band clamp 4100 according to the present disclosure is illustrated. This embodiment is similar to the embodiment illustrated in FIGS. 31 and 32, except that the second receiver 4114 is not associated with a land 4190. Rather, the first band end 4104 includes two parallel cuts 4126a and 4126b running parallel with the longitudinal axis of the band 4100 that extend to the first band end 4104. In the illustrated embodiment, the clamp 4100 may be formed from a single piece of material, including a tension and buckle section 4101 and a band 4102. The band 4102 includes a first band end 4104 and a second band end 4106. In the non-limiting embodiment, the cut 4126 made in the band results in the forming of land 4192a and 4192b and tail 4164. As illustrated in FIGS. 34 and 36A, the arms 4192a and 4192b are folded over at folds 4196 onto the band 4102 to form slot 4128 with opening 4194. Similar to the embodiment of FIGS. 29-31, the embodiment of FIGS. 34-36B may include indentations formed along the sides or lateral edges of the band. Here, there are eight indentations that abut to form four spacers. The indentations are 4162a, 4162b, 4162c, 4162d, 4162e, 4162f, 4162g and 4162h. In the non-limiting embodiment, the arms 4192a and 4192b are folded and the indentations abut to create spacers. The spacers also form connection points whereby the arms may be attached or secured to the band 4102 by welding at one or more of the pairs of indentations. It is appreciated that the number and location of the indentions may vary in different embodiments.

As shown in FIGS. 34A and 34B, the band 4102 has an inner surface 4110 and an outer surface 4108, and the outer surface 4108 has a first receiver 4112 and a second receiver 4114. Receiver 4114 may be formed in the band 4102 by stamping or may be separately attached to the outer surface 4108 of the band 4102. When the band 4102 is formed into a closed loop, a tongue 4158 of the second band end 4106 is received in the slot 4128 of the tension and buckle section 4101 in the same manner as described above in connection with the embodiment of FIGS. 29-32. The first receiver 4112 is positioned in and is movable within the slot 4128. Thus, at its largest diameter or circumference, the first receiver 4112 is located proximate to the folds 4196 of the tension and buckle section 4101. By moving the first receiver 4112 within the slot 4128, a diameter or circumference of the clamp 4100 increases or decreases accordingly. The tongue 4158 may be sized to have a width less than an overall width of the band 4102, such that the second band end 4106 can be received in the opening 4194 of the tension and buckle section 4101. The tongue 4158 may also be sized to have a width that creates an interference with the opening 4194 such that the tongue 4158 can be inserted into the opening 4194 with force and also held within the opening 4194 due to the interference. Alternatively, the height of a gap 4198 formed between the upper surface 4108 of the band and the folded over arms 4192 of the tension and buckle section 4101 may be slightly less than the thickness of height of the tongue 4158. The band clamp illustrated in FIGS. 34, 35 and 36A-36B may also include one or more of the staging features illustrated in FIGS. 21-28 and described in associated text.

Once the clamp 4100 is at a target diameter, e.g., properly tightened about a workpiece, the tool 116 may activate and lock the buckle 4118 to secure the diameter of the clamp 4100 and achieve a desired retained force. More specifically, in some embodiments, the tool moves a punch and deforms the band tongue 4158 of the band 4102 into an opening 4144 in the band 4102 proximate the first band end 4104. If a punch is used to secure the circumference of the band once the band is properly tensioned. It will be appreciated by those of skill in the art upon review of the present disclosure that other techniques may be utilized for securing the band circumference other than by use of a punch. For example, the circumference of a band may be secured by welding. More particularly, the tongue 4158 may be welded to the outer surface 4108 of the band and/or to the arms 4192a and 4192b.

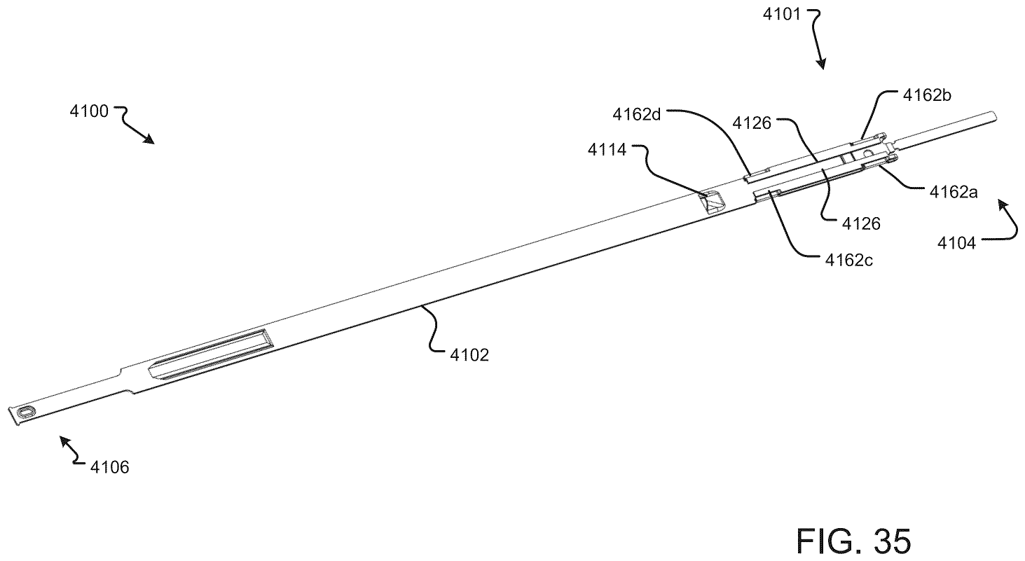

Optionally, the band 4102 may also include a weld plate 4170 as seen in FIG. 35. The weld pad 4170 is preferably formed by a stamping process to create a raised portion of the band 4102 along the outer surface 3108 of the band 3102 and within the length of the slot 4128. As best seen in FIG. 36B, the upper or outer surface 4172 is raised relative to the upper surface 4108 of the band and the lower or inner surface 4174 of the weld pad 4170 is raised from or away from the inner surface 4110 of the band. When the clamp 4100 is installed on a workpiece, the inner surface 4110 of the band wraps around and conforms to the workpiece surface. Because the weld pad 4170 is raised, the inner surface 4174 is spaced from the workpiece surface and the gap between inner surface 4174 and the surface of the workpiece defines a thermo-slot 4176. To tension the band, the tongue 4158 is inserted into the slot 4128 and the first receiver 4112 is moved toward the second receiver 4114. In the non-limiting embodiment, the upper surface 4172 of the weld pad 4170 is in contact with at least a portion of an inner surface 4178 of the tongue 4158 and the weld pad 4170 spaces the inner surface 4178 of the tongue 4158 from the outer surface 5108 of the band 4102. As a result, a space or slot 4180 is formed between the inner surface 4178 and the outer surface 4108. The tongue 4158 may now be welded to the band 4102 to secure the circumference of the band around the workpiece. When welding the tongue 4158 to the band, the slot 4180 and the thermo-slot 4176 create a shield and/or buffer to prevent or at least reduce heat produced by the welding process from damaging the surface of the workpiece.

The bands described previously herein have been shown as individual bands. For example, the individual bands may be formed by stamping, laser cutting or by other manufacturing methods known to those of skill in the art. As an alternative, the bands described herein may be made from a single continuous length of band material, with the individual bands connected end-to-end as part of the manufacturing process. Multiple band clamps may be formed in an interconnected fashion from a single length of band material, for example, by a stamping method. Other manufacturing methods known to those of skill in the art may be utilized.

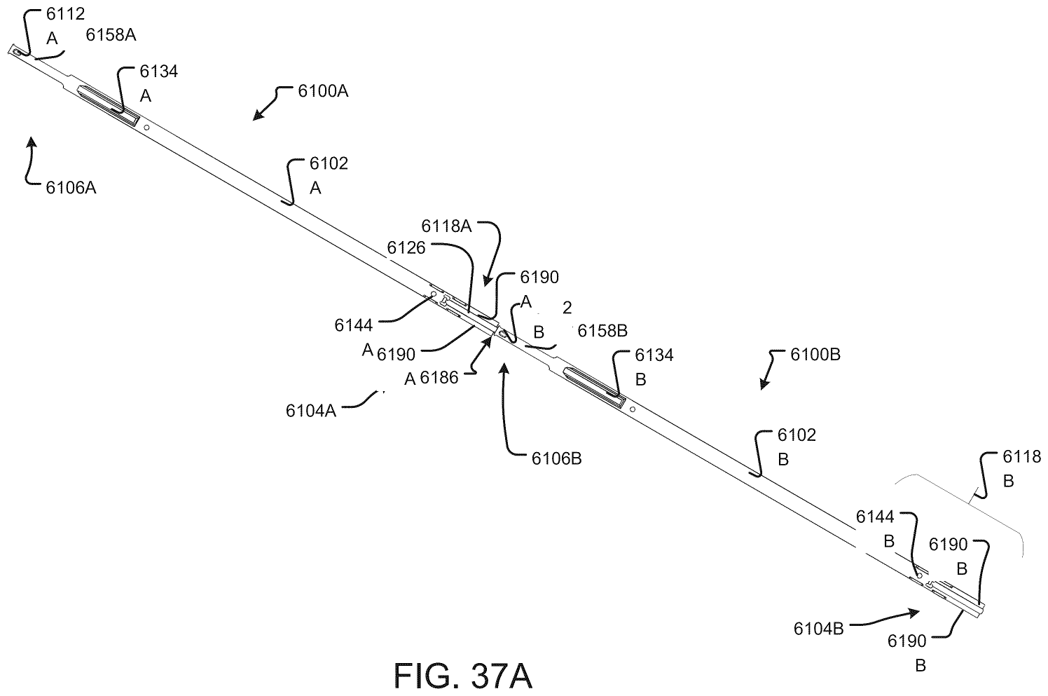

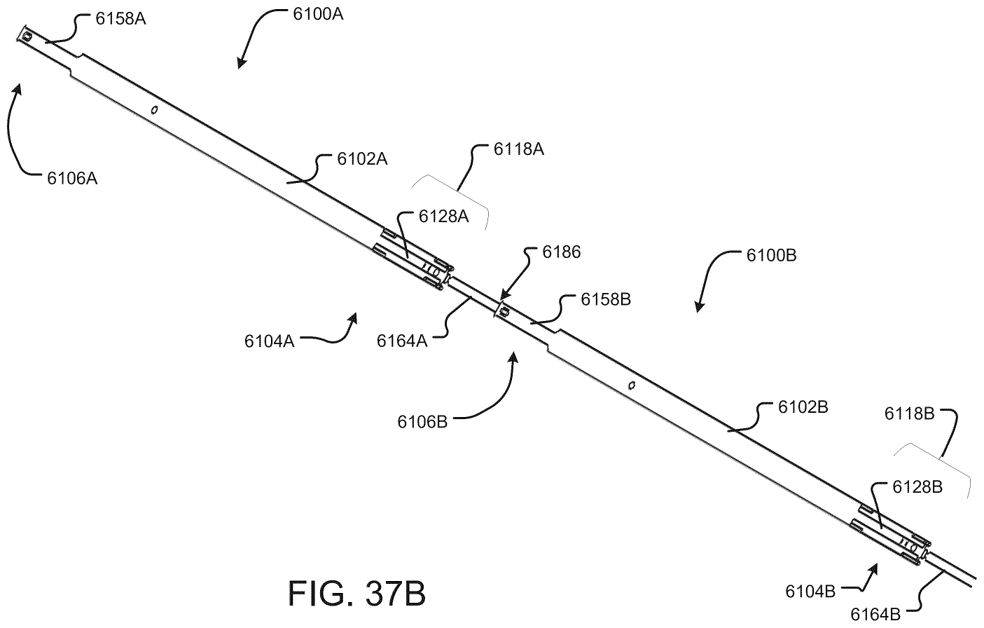

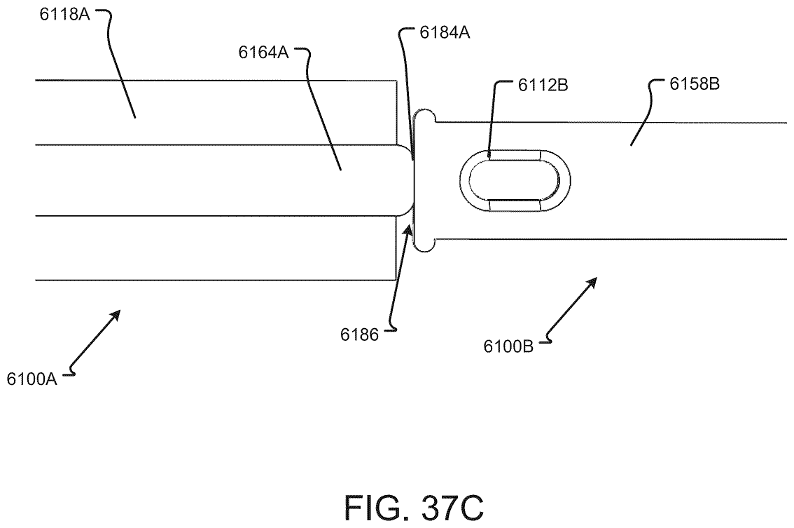

FIG. 37A provides a top view of two clamps 6100A and 6100B connected end-to-end in a flat or uncoiled state according to embodiments of the present disclosure. As part of the manufacturing process, certain features are initially created or formed. For example, tongues 6158A and 6158B are created with receivers 6112A and 6112B at the second band ends 6106A and 6106B. Depressions 6134A and 6134B are also formed, as are apertures 6144A and 6144B. In addition, the pre-folded tension and buckle section 6118A and 6118B are created.

FIG. 37B illustrates a subsequent step in the manufacturing process. Here, the tension and buckle sections 6118A and 6118B have been folded creating slots 6128A and 8128B and exposing tails 6164A and 6164B. In a subsequent step, the arms 6192a and 6192b may be connected to the upper surfaces 6108A and 6108B by welding or other connection methods at locations 6160 and 6162. Band 6100A is connected to band 6100B at location 6186.

FIG. 37C provides a detailed view of the connecting section 6186 between the first clamp 6100A and the second clamp 6100B as also shown in FIG. 37A, before the folding of tension and buckle section 6118. The first end 6184 of tail 6164A of band 6100A is integral with the tail 6158B of the second clamp 6100B at the connection section 6186. The connecting section 6186 may be constructed with a serration at the junction (not shown in the figures) so that technicians can disconnect the two clamps 6100A and 6100B without a tool.

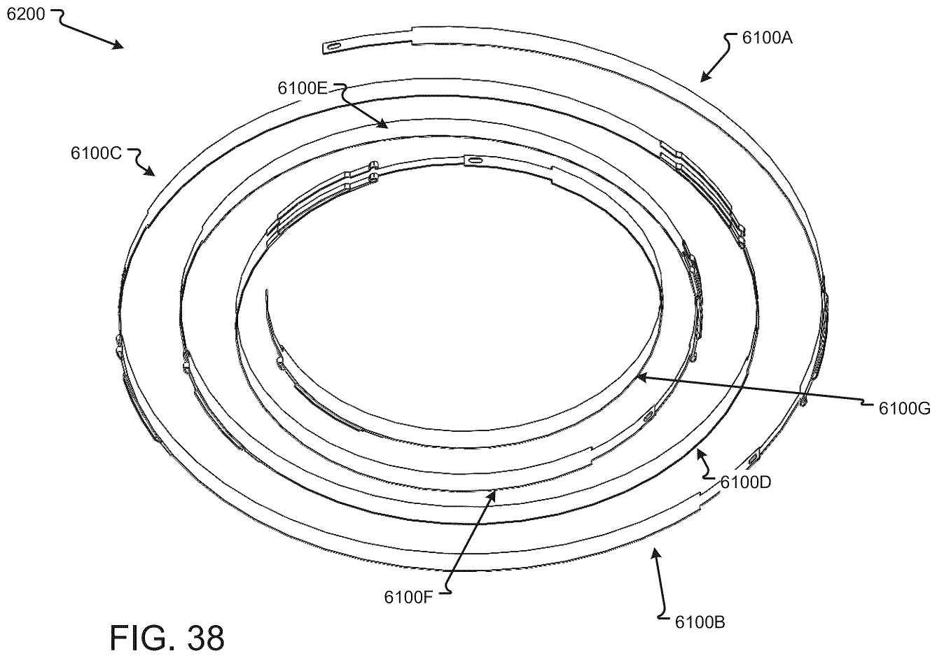

FIG. 38 illustrated a plurality of interconnected bands 6100_{A-X} in a coiled bundle 6200. The number of the clamps in one clamp reel or bundle may vary depending upon the installation scenario. For example, in the context of a workstation where ban installation is repetitively performed, a reel or bundle 6200 of interconnected bands 4100 may be provided for the benefit of an installer. Individual bands 6100 may be disconnected from the bundle as needed by the installer. The disconnection may be manually performed by the installer or a tool may be used to disconnect individual bands. Alternatively, an automated dispensing tool or machine may be used where bands are individually expelled and cut from the bundle.

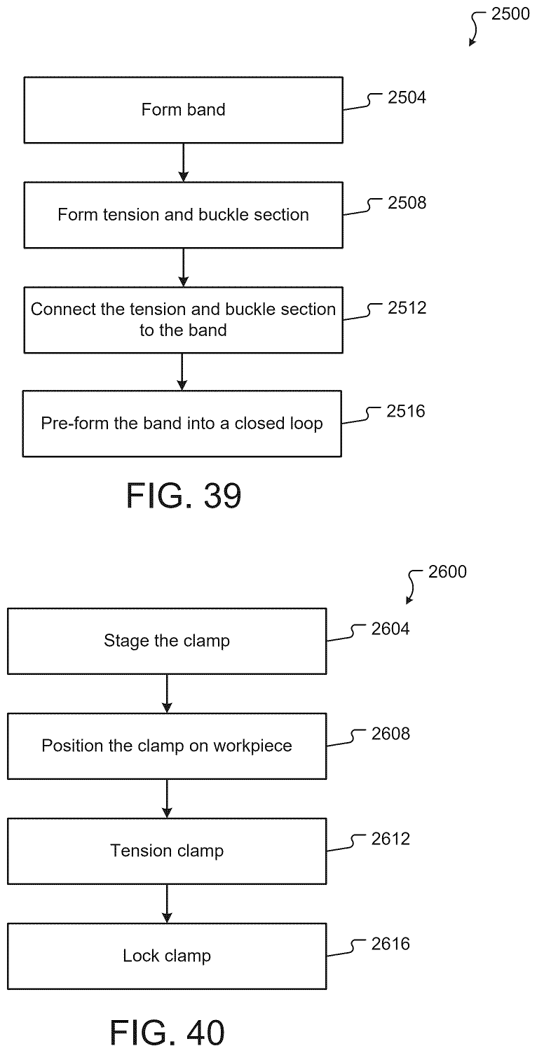

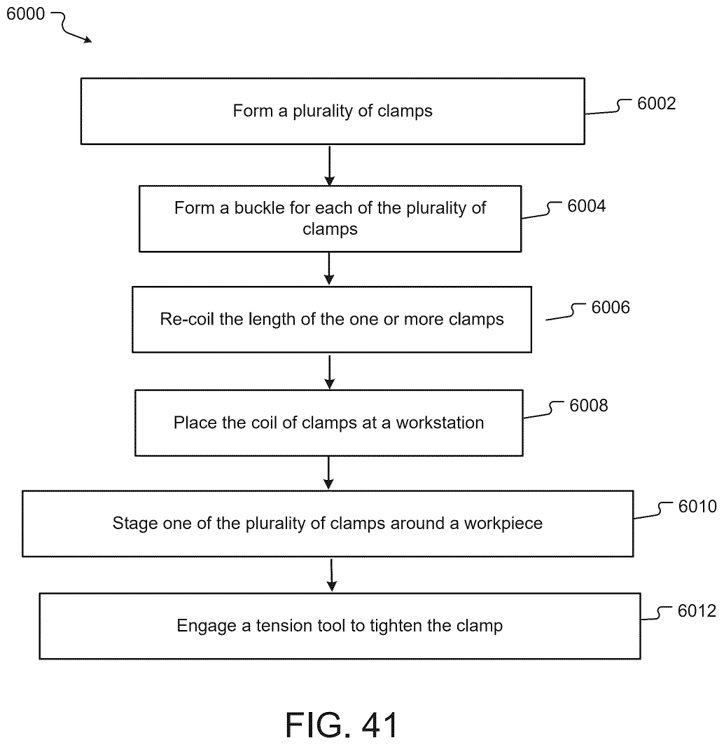

The bands described in the present disclosure may be manufactured by different methods. A first method of manufacturing 2500, illustrated in FIG. 39, includes initially forming a band 102 (step 2504). The band may be formed from a single sheet of material such as, for example, a metal sheet, a metal alloy sheet, or a plastic sheet. The band may be formed by stamping, cutting, or machining the sheet of material to the shape of the band, resulting in the band without the tension and buckle section 101, as shown in FIGS. 7 and 8.

The method of manufacturing 2500 also includes forming a tension and buckle section such as the tension and buckle section 101 (step 2508), shown in FIGS. 2-4. In some embodiments, the tension and buckle section may be formed from the same sheet of material as the band. In other embodiments, the buckle is formed from a separate sheet of material. The bands 102 and buckles 101 may be formed at the same time, using the same machine, for example, a press, or may be formed sequentially.

Features of the band and the tension and buckle assembly may be made as part of steps 2504 and 2508. For example, first receiver 112, depression 134, dimples 158, friction feature 162 and ramp 166 may be formed as part of forming the band (step 2504). Similarly, second receiver 114, legs 130a and 130b of tab 130, wings 156, dimples 158, hooks 160 and dimples 164 may be formed as part of forming the tension and buckle assembly (step 2508). Forming the tension and buckle section 101 may further include folding the legs 130a and 130b of tab 130.

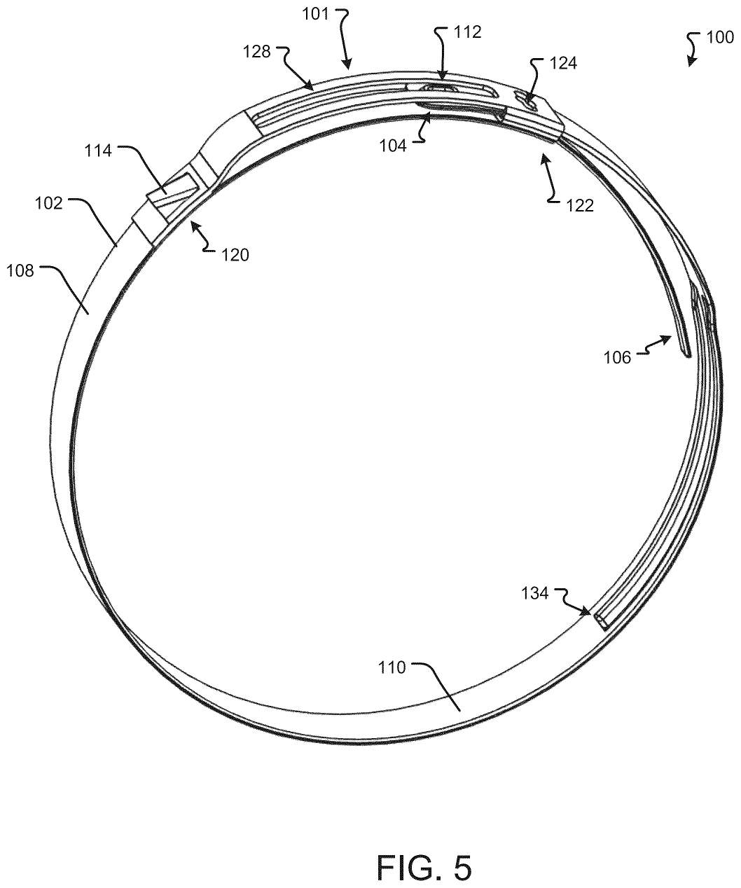

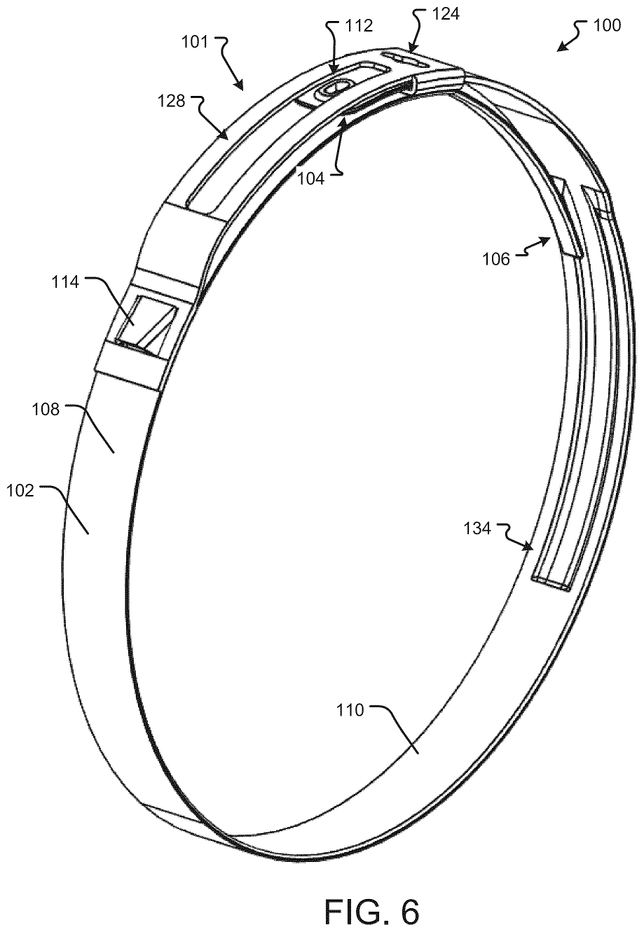

The method of manufacturing 2500 next requires connecting the tension and buckle section 101 to the band 102 (step 2512). In some embodiments, the tension and buckle section is welded or otherwise connected to the band. The band with the tension and buckle section attached to the band is shown in FIGS. 9-10. The clamp may be inventoried or shipped as a flat band, as shown in FIGS. 9-10. In an additional optional step (step 2516) the band may be pre-formed into a circular shape, as shown in FIGS. 5 and 6. If an installer receives the clamp in a flat state, the user will wrap the clamp around the workpiece or may pre-form the band into the circular shape and then place it on a workpiece. In other instances, if the installer receives the clamp in a pre-formed circular state, the installer will place the clamp on a workpiece without first pre-forming it. The method 2500 may not include the step 2516 in some embodiments, or may be performed as part of the method of installation 2600, described below.

A method of installation 2600 used to install the band or pre-formed clamp onto a workpiece, as illustrated in FIG. 40, will now be described. If the band is not pre-formed into a closed loop but is provided as a flat band with the tension and buckle section attached, in step 2604, the band is first formed into a closed loop or staged. If the band is provided to an installer in a pre-formed closed-loop state or following forming the band into a closed loop, the method of installation 2600 next includes positioning the pre-formed clamp over a workpiece (step 2608). The workpiece may include, for example, a CV boot positioned over a CV joint. Positioning the clamp over the workpiece may include sliding the clamp over the workpiece in instances where a closed or coiled diameter of the clamp is greater than a diameter of the workpiece. In instances where the work piece has a shape or configuration that prevents a pre-formed clamp from being placed onto a work piece, the clamp may be simultaneously staged and positioned, in the case of a flat band, or if the installer is provided with a closed loop band, the band will be opened in order that the band may be positioned over the workpiece. The band may then be staged or formed into a closed loop about the workpiece.

The clamp may be staged using one or more various staging features. The staging features may include, for example, at least one raised feature such as the at least one raised feature 156, at least one hook or pair of hooks such as the at least one set of hooks 160, and/or at least one friction feature such as the at least one friction feature 162 as illustrated in FIGS. 21-28 and described herein. The at least one raised feature may include a plurality of raised features that permit the band to be staged in a closed loop configuration at one or more different diameters or circumferences.

The method of installation 2600 also includes tensioning the clamp (step 2612) and locking the clamp (step 2616). The clamp may be tensioned and locked using a tool such as the tool 116. The tool includes a first hook such as the first hook 146 configured to hook a first receiver, such as the first receiver 112 of a band, and a second hook, such as the second hook 149, is configured to hook a second receiver such as the second receiver 114 of the band. The first hook and the second hook move the first receiver and the second receiver towards each other to tension the band. Once the band is at a sufficient or desired tension, a punch such as the punch 151 punches a buckle such as the buckle 118 and the band to deform the band, thereby locking the band in place. In other embodiments, the clamp may be tensioned and locked using a tool configured to attach to or hold the tension and buckle section while moving the first receiver to tension the clamp. The clamp can then be punched or otherwise secured, such as by welding or crimping, at or proximate the first receiver. In such embodiments, the clamp may not include, for example, the aperture associated with a punch operation. In still other embodiments, the clamp may be locked by, for example, a mechanical lock, adhesion, and/or lip lock. It should be appreciated that the tool 116 illustrated in FIG. 20 may be used with each of the band clamp embodiments illustrated and described herein.

Turning to FIGS. 419, a method 6000 of manufacturing and installing a plurality of clamps (or bands) is shown. In the non-limiting embodiment, the plurality of clamps are formed (step 5002) from a continuous length of metal, typically provided in a coil. A machine then stamps or cuts the plurality of clamps from the metal, maintaining an end-to-end connection between each successive clamp. It is appreciated that the plurality of clamps 6002 may also be formed from a single sheet of material such as, for example, a metal sheet or a metal alloy sheet

Once the band with its attendant features is formed (e.g., as shown in FIG. 37A), a next step in the method of manufacturing 6000 includes forming the buckle (step 6004). As illustrated in FIG. 37A, band includes two arms 6192a and 6192b in an unfolded. As illustrated in FIG. 37B, the arms 6192a and 6192b are then folded forming the tension and buckle section 6101 and the slot 6128, and leaving the tail 6164. In a subsequent step, the arms 6192a and 6192b are secured to the band by welding.

The plurality of clamps are then re-coiled (step 6006) into a reel of clamps, as shown in FIG. 38, and are ready to be placed at a workstation (step 6008). For example, the reel of clamps may be placed in an airbag installation workstation. As each new airbag subassembly is positioned at the workstation, a machine holding the reel of bands discharges a single band, cutting off a band from the remaining interconnected bands in the reel.

The method of installation 6000 further includes staging a band around a workpiece to form a partially closed loop (step 6010). This step may be achieved fully manually by an installer. Alternatively, an automated or robotic machine may be configured to stage the band about a workpiece by inserting a tongue of a band into a slot of a band with any of the embodiments described herein, forming a closed loop around the workpiece. In some embodiments, this step combines machine and manual operations by having the machine form the band into a closed loop, and the worker manually positions the closed-loop clamp around the workpiece. Once the clamp is correctly placed around the workpiece, the worker may engage the tensioning tool to tighten the clamp (step 6012) and complete the installation.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims.

What is claimed is:

1. A band clamp comprising:
a band extending from a first band end to a second band end, the band having an outer surface and an inner surface, the band having a first receiver positioned at the outer surface proximate the first end; and
a tension and buckle section fixed to the outer surface of the band and having a first end and a second end spaced from the first end, and a slot in the tension and buckle section that extends from proximate the second end to proximate the second receiver,
wherein, when the first receiver is positioned within the slot, the band forms a closed loop defining a circumference with the first receiver movable within the slot relative to vary the circumference of the closed loop.

2. The band clamp of claim 1, wherein the tension and buckle section further comprises a second receiver disposed at the first end of the tension and buckle section.

3. The band claim of claim 1, further comprising a second receiver disposed on the upper surface of the band proximate the first end of the tension and buckle section.

4. The band clamp of claim 2, further comprising a buckle disposed at the second end of the tension and buckle section, the buckle having a first opening spaced outwardly from the outer surface of the band.

5. The band clamp of claim 1, wherein the tension and buckle section is a component formed separate from the band.

6. The band clamp of claim 1, wherein the tension and buckle section further comprises at least one staging feature configured to hold the band in a closed loop configuration.

7. The band clamp of claim 6, wherein the at least one staging feature comprises at least one of a raised feature, a friction feature, or a hook.

8. The band clamp of claim 1, wherein the band has a longitudinal axis defined by the first band end and second band end, the clamp further comprising a tail extending outwardly from the second band end parallel to the longitudinal axis of the band.

9. The band clamp of claim 8, further comprising a depression disposed on the inner surface of the band and configured to capture the tail when the clamp is configured in a closed loop.

10. The band clamp of claim 4, wherein the buckle comprises an outer portion having a first side and a second side spaced laterally from the first side, a first leg subtending and extending inwardly from the first side and second leg subtending and extending inwardly from the second side.

11. The band clamp of claim 2, wherein the first end of the tension and buckle section is secured to the outer surface of the band.

12. The band clamp of claim 6, further comprising a buckle disposed at the second end of the tension and buckle section, the buckle having a first opening spaced outwardly from the outer surface of the band; and at least one dimple extending outwardly from the outer surface of the first band end, and wherein, when the band is configured in a closed loop, the at least one dimple is configured to engage the first opening and hold the band in the closed loop configuration.

13. The band clamp of claim 12, wherein the at least one dimple comprises a plurality of dimples longitudinally aligned along the outer surface of the first band end.

14. The band claim of claim 4, further comprising a protrusion extending outwardly from the outer surface of the band proximate the second band end, wherein, when the band is configured in a closed loop with the first band end positioned in the slot, the protrusion frictionally engages the inner surface of the first band end.

15. The band clamp of claim 8, wherein the slot has a width that is perpendicular to the longitudinal axis of the band, the tension and buckle section further comprising at least one hook extending into the slot and forming a restriction in the width of the slot, the at least one hook configured to engage the first receiver and prevent the first receiver from moving away from the second receiver.

16. A method for manufacturing a band, the method comprising:
forming a band from a piece of material, the formed band having a first band end and a second band end spaced from the first band end, the band having an outer surface and an inner surface, the band having a first side and a second side spaced from the first side;
making two parallel slots through the band proximate the second band end to create a first arm comprising a portion of the first side of the band and a second arm comprising a portion of the second side of the band, the first arm spaced from the second arm, the two slots having a first end and a second end, the second end of the two slots being closer to the second band end than is the first end of the two slots;
folding each of the first and second arms proximate the second end of the two slots to form a tension and buckle section having an open slot that is spaced from and extends along a portion of the outer surface of the band; and
connecting the first and second arms to the outer surface of the band.

17. The method of claim 16, wherein forming a band from a piece of metal comprises forming a first receiver and forming a second receiver.

18. The method of claim 16, wherein forming a band from a piece of material comprises forming at least a first protrusion along the first side of the band and at least a second protrusion along the second side of the band, and wherein the step of folding the first and second arms causes the first protrusion to contact the second protrusion and causes the first arm to be spaced from the outer surface of the band.

19. The method of claim 18, wherein the step of connecting the first arm to the outer surface of the band comprises welding the first protrusion to the second protrusion.

20. The method of claim 16, wherein forming a band from a piece of metal comprises forming a staging feature protruding from the outer surface of the band.
